(19) United States
(12) Patent Application Publication
(10) Pub. No.: US 2002/0167665 A1
(43) Pub. Date: Nov. 14, 2002

(54) High-throughput methods of distinguishing at least one molecule individually in a sample comprising multiple molecules and systems for use therein

(76) Inventors: Edward S. Yeung, Ames, IA (US); Michael Shortreed, Portage, WI (US); Yinfa Ma, Rolla, MO (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/031,353

(22) PCT Filed: May 18, 2001
(86) PCT No.: PCT/US01/16187

(30) Foreign Application Priority Data
May 19, 2000 (US) 60/205832

(51) Int. Cl. G01N 21/00

(52) U.S. Cl. 356/344

(57) ABSTRACT

A high-throughput method of distinguishing at least one molecule individually in a sample comprising multiple molecules, which method comprises: subjecting a sample comprising multiple molecules, at least one molecule of which is detectably labeled, to electrophoresis; imaging the electrophoretic mobility of each detectably labeled molecule over time by detecting the position of the detectable label of each detectably labeled molecule over time, and, optionally, at the same time, dispersing the imaging by a transmission grating for spectroscopic analysis, and determining the electrophoretic mobility of each detectably labeled molecule and, optionally, determining the molecular spectrum of each detectably labeled molecule, thereby distinguishing at least one molecule individually in a sample comprising multiple molecules, and a system for use in such a method. A second high-throughput method of distinguishing at least one molecule individually in a sample comprising multiple molecules, which method comprises: introducing a sample comprising multiple molecules in free solution, at least one molecule of which is detectably labeled, into a sample channel; simultaneously imaging the position of each detectably labeled molecule, by detecting the position of the detectable label of each detectably labeled molecule, and dispersing the imaging by a transmission grating for spectroscopic analysis, and determining the molecular spectrum of each detectably labeled molecule, thereby distinguishing at least one molecule individually in a sample comprising multiple molecules, and a system for use in such a method.

### STATEMENT OF GOVERNMENT RIGHTS

This invention was made with government support under Department of Energy Contract No. W-7405-Eng-82 and National Institutes of Health Contract Nos. RO 1 CA76961-04A1 and 5R01 CA76961-02. Therefore, the government of the U.S.A. may have certain rights in this invention.

### TECHNICAL FIELD OF THE INVENTION

The present invention relates to high-throughput methods of distinguishing at least one molecule individually in a sample comprising multiple molecules and systems for use in such a method. Electrophoresis, immunoassay, fluorescence and spectroscopy are employed.

### BACKGROUND OF THE INVENTION

Currently, there are no commercially available systems that enable a single molecule to be distinguished from other molecules. Flow cytometers, for example, are commercial instruments that can characterize one cell at a time, but the sensitivity is only sufficient when thousands of fluorescent target molecules are present per cell. Fluorescence microscopy also does not have single-molecule sensitivity. ELISA tests are only useful to around 10⁻¹² M or 109 copies of antigen per milliliter. The most sensitive PCR tests (e.g., for HIV RNA) require 20-50 copies per milliliter. Sample preparation times and incubation times for ELISA and PCR are around 1 hour for at most 96 samples at a time.

In view of the growing numbers of patients with cancer, HIV, tuberculosis, hepatitis and other diseases worldwide, a number of amplification procedures recently have been developed that significantly improve detection and quantitation of various nucleic acid-based etiological agents for which rapid detection is critical. Selective amplification has reduced the need for labor-intensive cell culturing in the case of tuberculosis and the need for repeated serological testing in the early stages of HIV-1 infection. The need for amplification was prompted by the extremely low copy number of such nucleic acid sequences (e.g., 50-11,000,000 HIV-1 virions per milliliter of plasma (Piatak et al., Science 259: 1749-1754 (1993)) for many samples and the need to produce detectable and quantifiable amounts. Unfortunately, these amplification procedures are, themselves, quite lengthy, often requiring several hours to complete. Additional complications arise from inconsistencies in the amplification efficiencies, which are further exacerbated by the significant variability of clinical samples.

In addition, sensitive detection of biomolecules depends not only on obtaining enough signal but often hinges on being able to recognize the targeted species in an overwhelming excess of very similar molecules. To this end, hybridization probes for DNA and antibodies to selected antigens are the most generally useful classes of highly specific probes for biorecognition. Basically, one needs to be able to distinguish the bound from the unbound probe molecules.

Heterogeneous assays amplify detection, since the bound and unbound components arrive at the detector one at a time. Separation before detection, however, is not always trivial. Binding of the excess probe on a clean-up stationary phase may not be complete, so a background can still exist. Also, the targeted species can adsorb onto the stationary phase, albeit slightly, and will go undetected. This will preclude working with very small amounts of material.

Homogeneous assays are easy to implement, since everything can be done in one step. Adaptation to automated and high-throughput operation is more straightforward. On the other hand, since both bound and unbound forms of the probe are present simultaneously, the selectivity of the detector becomes critical in such applications.

Florescence-based homogeneous assays are the most promising candidates for single-molecule recognition. However, when existing variations of these assays are applied to selective detection, many limitations exist.

For example, for those assays that employ fluorescence quenching upon binding, the decrease in the intensity of fluorescence upon binding is rarely 100% (Parkhurst et al., Biochem. 34: 285-292 (1995)); thus, one needs a very good signal to noise ratio to observe a decrease in fluorescence intensity. Also, one needs to distinguish the absence of a species from observing a species with little or no fluorescence. Furthermore, photobleaching can be confused with quenching.

Likewise, for those assays that employ fluorescence enhancement upon binding, a very good signal to noise ratio is still needed, even though problems with background emission are less severe, since one rarely has a totally nonfluorescent probe and the probe is typically in large excess to favor binding. Intercalation dyes for DNA (Kim et al., Anal. Chem. 66: 1168-1174 (1994)) represent the extreme in fluorescence enhancement on binding, but these probes are not specific. In addition, while the relative intensities of dsDNA stained with intercalating dyes have been used to size DNA, the precision is quite poor.

For those assays that measure fluorescence spectral shifts and energy transfer, conceptually, the change in the emission spectrum can provide excellent discrimination between a bound and an unbound probe. While spectra have been acquired on single molecules (Macklin et al., Science 272: 255-258 (1996)), spreading the total emitted photons over several spectral elements puts even greater demands on detection sensitivity. Also, even for the highly favorable case of energy transfer (Parkhurst (1995), supra), there is always a background due to light absorption by the free acceptor and residual emission by the bound donor. Energy transfer sometimes requires labeling the target as well, which is not practical for the small volumes and the low concentrations typically found in biological systems.

The simultaneous presence of two fluorescent labels has been used to recognize binding of biomolecules in the presence of unbound species (Brau et al., Abstract No. 29, ACS Spring Meeting, San Francisco (1997); Castro et al., Anal. Chem. 69: 3915-3920 (1997)). These are counted one at a time in a sheath flow. In addition to the lower throughput compared to imaging many molecules at a time, synchronous detection also requires the targeted molecule to be labeled, which is often impractical.

Luminescence lifetimes have been obtained from single molecules (Macklin (1996), supra; Tellinghusen et al., Anal. Chem. 66: 64-72 (1994)). The degree of discrimination, based on a change in fluorescence lifetime, depends on the signal to noise ratio. The need to cycle the molecule many times through the excited state to determine one lifetime further limits the overall data rate and the suitability for multiplexed operation.

In assays employing fluorescence depolarization, the resulting difference in the measured intensity due to a change in polarization on binding is much smaller than quenching or enhancement (Wirth et al, Anal. Chem. 63: 1311-1317 (1991)). Therefore, an even greater demand is placed on the signal level.

Fluorescence correlation spectroscopy (FCS) relates the time a fluorophor spends in the path of a tightly focused laser beam to its molecular weight via the simple Einstein diffusion relation. One can thus determine if a fluorophor is diffusing freely in solution or is bound to a larger molecule like a protein or a strand of DNA. As early as 1981, FCS was used to perform a fluorescent homogeneous competitive immunoassay for gentamicin (Briggs et al., Science 212: 1266-1267 (1981)). Here, fluorescently labeled gentamicin and unlabeled gentamicin from an unknown sample competed for antibody binding sites on a relatively large 460 nm latex sphere. The amount of fluorescent gentamicin bound to the sphere was easily determined because the diffusion constant of the sphere was small relative to free gentamicin and hence fluorophors bound to it remained in the excitation path longer. The detection limit was reportedly as low as 1 ng/ml in a sample as small as 10 μl. There are reports regarding the use of small fluorescent labeled DNA probes to locate larger target DNA strands (Kinjo et al., Nucl. Acids Res. 23: 1795-1799 (1995)). Most recently, FCS has been used to monitor the hybridization kinetics of DNA probes binding to RNA (Schwille et al., Biochem. 35: 10182-10193 (1996)) to detect HIV-1 RNA in plasma (Oehlenschlager et al., PNAS USA 93: 12811-12816 (1996)) and to quantitate various pathogens, such as Mycobacterium tuberculosis genomic DNA.

Though FCS has the sensitivity to detect single molecules, amplification procedures are still required because the detection efficiency is very poor. The FCS technique requires the use of a tightly focused laser beam to form a sampling zone with a 1 fl (1×10⁻¹⁵ l) effective volume. Though this volume can be probed for several seconds, detection still depends on random diffusion through the excitation zone. Since the actual sample volume is typically on the order of 10 μl, FCS probes only 1 in 10 billion of the molecules in the sample, thereby missing most molecules entirely. Thus, quantification may be severely affected by variations in mixing efficiency, repeated sampling of the same molecule (Nie et al., Science 266: 1018-1021 (1994)) and sample adsorption to the walls. Optical trapping within the volume of excitation is possible. The loss of correlation may be caused by crossing into the triplet state (Nie et al., Anal. Chem. 67: 2849-2857 (1995)). Orientational effects with respect to the electric field vector also need to be accounted for (Bezig et al., Science 262: 1422-1425 (1993)). The single-point approach also precludes highly-multiplexed measurements.

Immuno-polymerase chain reaction (immuno-PCR) makes use of double- and single-stranded DNA-antibody conjugates to enhance the sensitivity by 2-3 orders of magnitude over traditional enzyme-based immunoassays (Sano et al., Science 258: 120-122 (1992); Joerger et al., Clin. Chem. 41: 1371-1377 (1995)). The concept of immuno-PCR is quite similar to conventional immunoassays and appears to be amenable to all known formats (e.g., sandwich, competitive, homogeneous; etc.). For example, in the competitive assay format, the DNA-bound antibody conjugate competes with free antibodies in the sample solution for a limited number of surface-bound antigens. The targeted antibody binds to the antigen, giving this type of assay its extraordinary selectivity. This is followed by washing and PCR amplification of the DNA fragment which was attached to the bound antibody (Kricka, Clin. Chem. 40: 347-357 (1994)). The first report of immuno-PCR had a detection limit of 580 molecules (Sano (1992), supra) and sub-attomole detection limits are not uncommon (Joerger et al. (1995), supra; Hendrickson et al., Nucl. Acids. Res. 23: 522-529 (1995)). Immuno-PCR was used to measure low levels of viral antigens (e.g., hepatitis B (Wu et al., J. Virol. Methods 49: 331-341 (1994); Maia et al., J. Virol. Methods 52: 273-286 (1995)) with a limit of detection below other currently available immunoassays (Maia et al. (1995), supra). Even in light of such high specificity and low detection limits, immuno-PCR still falls victim to the common pitfalls associated with all PCR-related techniques, i.e., long preparation times and variability in amplification efficiency.

Flow cytometry (see, e.g., Shapiro, Practical Flow Cytometry, 3^{rd} ed., Wiley-Liss, New York (1995), for review) is an automated method with extreme flexibility capable of analyzing a number of intrinsic (size, shape, cytoplasmic granularity, absorbance, autofluorescence; etc.) and extrinsic (fluorescence from stained DNA, RNA, chromatin, protein, antibodies, etc.) biological cell properties. An important example of the measurement of an extrinsic property is the determination of abnormalities of DNA content in tumor cells. Even with the apparent flexibility, flow cytometry is limited, by the intrinsic cellular autofluorescence. Cellular autofluorescence hampers detection of extrinsic fluorescent labels with numbers below several hundred per cell and virtually eliminates the possibility of detecting a single fluorescent tag. One report likened the autofluorescence from an unstained human lymphocyte to be similar in intensity to that of 500-1,500 fluorescein molecules (Shapiro (1995), supra). Though effects of many background contributors may be partially mitigated by using longer excitation wavelengths and time-resolved detection, there is, as of yet, no clear way of obtaining single-molecule sensitivity from an intact biological cell.

Fluorescence in situ hybridization (FISH) is among the most promising of the currently available tools for genetics research and clinical diagnostics. Applications include detecting birth defects, like Down's syndrome, using uncultured amniocytes (Pierluigi et al., Clin. Genet. 49: 32-36 (1996)), pre-operative diagnosis of breast carcinomas from fine-need aspirations (Ichikawa et al., Cancer 77: 2064-2069 (1996)) and pre-implantation chromosomal screening (Pellestor et al., Cytogenet. Cell Genetics 72: 34-36 (1996)). In fact, the flexibility continues to grow, especially with the advent 15. of combinatorial techniques (Ried et al., PNAS USA 89: 1388-1392 (1992); Nederlof et al., Cytometry 11: 126-131 (1990)) and alternative labeling schemes like the primed in situ (PRINS) technique (Pellestor et al. (1996), supra). The FISH technique is based on hybridization of a specific nucleic acid sequence in cells, tissue, interphase nuclei or metaphase chromosomes with a fluorescently tagged or taggable (e.g., hapten) complementary sequence. Several different targets may be visualized in the same sample by using probes of differing emission wavelengths (Ried et al. (1992), supra; Nederlof et al. (1990), supra). However, not unlike flow cytometry, the FISH technique is also hampered by the ordinarily high levels of cellular autofluorescence, especially with decreasing locus-specific probe sizes (Szollosi et al., Cytometry 20: 356-361 (1995)). Also, at the present stage, FISH involves tedious sample work-up and is not readily adapted for high-speed, high-throughput applications.

At the single-molecule level, electrophoretic mobility has been reported in a micrometer-sized flow stream by correlating the photon bursts created at two laser beams that are axially separated (Castro et al., Anal Chem. 67: 3181-3186 (1995)) or by autocorrelation of photon bursts within a single laser beam (Van Orden et al., Anal. Chem. 70: 4463-4471 (1998)). In both systems, only one DNA molecule can be probed and the measurement time is limited by the distance of separation between the two laser beams.

Hydrodynamic focusing and microdroplets have been used to detect the presence of single molecules. However, neither technique enables one to distinguish between molecules of different types.

Thus, in view of the above, there remains a need for new analytical methods with sensitivities and detection limits appropriate for non-amplified samples. Ideally, a method would permit recognition down to the level of a single analyte molecule in a single biological cell. Such information would be expected to correlate more exactly with the progression of disease, for example. Existing systems and methods either do not have single-molecule sensitivity or do not image every molecule (e.g., FCS) or require long preparation times (e.g., FISH) or have extremely low throughput (e.g., fluorescence lifetimes). The present invention seeks to provide such methods and systems. These and other objects and advantages of the present invention will become apparent to those of ordinary skill in the art upon reading the detailed description set forth herein.

### BRIEF SUMMARY OF THE INVENTION

The present invention provides a high-throughput method of distinguishing at least one molecule individually in a sample comprising multiple molecules. In one embodiment, the method comprises subjecting a sample comprising multiple molecules, at least one molecule of which is detectably labeled, to electrophoresis. The method further comprises imaging the electrophoretic mobility of each detectably labeled molecule over time by detecting the position of the detectable label of each detectably labeled molecule over time and, optionally, at the same time, dispersing the imaging by a transmission grating for spectroscopic analysis, and further determining the electrophoretic mobility of each detectably labeled molecule and, optionally, determining the molecular spectrum of each detectably labeled molecule. The method enables at least one individual molecule in a sample comprising multiple molecules to be distinguished.

The present invention further provides a system for use in such a method. The system comprises an electrophoretic sample channel, into which is introduced a sample comprising multiple molecules, at least one molecule of which is detectably labeled with a fluorescent label, a light source, which irradiates the electrophoretic sample channel and comprises or consists essentially of at least one wavelength of light that causes at least one molecule in the sample comprising multiple molecules that is detectably labeled with a fluorescent label to fluoresce, an imaging means, which images the electrophoretic mobility of each detectably labeled molecule in the sample over time, and, optionally, a transmission grating, which disperses the imaging of the electrophoretic mobility of each detectably labeled molecule in the sample.

Further provided by the present invention is yet another high-throughput method of distinguishing at least one molecule individually in a sample comprising multiple molecules. The method comprises introducing a sample comprising multiple molecules in free solution, at least one molecule of which is detectably labeled, into a sample channel, simultaneously imaging the position of each detectably labeled molecule, by detecting the position of the detectable label of each detectably labeled molecule, and dispersing the imaging by a transmission grating for spectroscopic analysis, and further determining the molecular spectrum of each detectably labeled molecule, thereby distinguishing at least one molecule individually in a sample comprising multiple molecules.

Still further provided by the present invention is a system for use in the preceding method. The system comprises a sample channel, into which is introduced a sample comprising multiple molecules in free solution, at least one molecule of which is detectably labeled with a fluorescent label, a light source that irradiates the sample channel and comprises or consists essentially of at least one wavelength of light that causes at least one molecule in the sample comprising multiple molecules that is detectably labeled with a fluorescent label to fluoresce, an imaging means, which images the position of each detectably labeled molecule in the sample, and, a transmission grating, which simultaneously disperses the imaging of the position of each detectably labeled molecule in the sample.

### BRIEF DESCRIPTION OF THE FIGURES

FIG. 1 is a photograph of the experimental set-up for single-molecule electrophoresis.

FIG. 2 is a diagram of the optical set-up for single-molecule electrophoresis in which “Laser” is a Coherent Innova 90 Argon Ion laser, “AO” is an Isomet Model 1205c Acousto-Optic Modulator, “PH1” is a pinhole section of 1ₛₜ order diffracted beam, “PR” is an equilateral prism, “M1,” “M2” and “M3” represent steering mirrors, “PH2” and “PH3” represent laser alignment pinholes, “L” is an f=1” plano-convex lens, “C” is a capillary and holder, and “M1” is a microscope.

FIG. 3 is a sequence of nine consecutive images, read left to right and top to bottom, of three separate λDNA molecules labeled with YOYO-1 and analyzed in accordance with the multi-frame method.

FIG. 4 is a comparison of a bulk electropherogram (bottom panel, fluorescence vs. time (min)) with a histogram (top panel, frequency vs. time (min)) of migration times predicted from the single-molecule mobilities based on the DNA assay results of 2 kb vs. 48.5 kb.

FIG. 5 is a sequence of nine consecutive images, read left to right and top to bottom, of several separate λDNA molecules labeled with YOYO-1 and analyzed in accordance with the streak method.

FIG. 6 is a sequence of nine consecutive images, read left to right and top to bottom, of several separate λDNA molecules labeled with YOYO-1 and analyzed in accordance with the multi-spot method.

FIG. 7 is a sequence of three consecutive images, read top to bottom, of a mixture of 16.5 kb and 6.1 kb fragments derived from human mitochondrial DNA (mtDNA), labeled with YOYO-1 and analyzed in accordance with the multi-frame method.

FIG. 8 is a histogram of frequency vs. migration time (mins) showing the predicted migration times in capillary electrophoresis obtained from single-molecule images for a mixture of 6.1 kb (left group) and 16.5 kb (right group) fragments derived from human mtDNA.

FIG. 9 is a sequence of three consecutive images, read top to bottom, of β-phycoerythrin-labeled digoxigenin (1) and its immunocomplex (2) in capillary electrophoresis.

FIG. 10 is comparison of a bulk electropherogram (bottom panel, fluorescence vs. time (min)) with a histogram (top panel, frequency vs. time (min)) of migration times predicted from the single-molecule mobilities based on the digoxin immunoassay results (β-phycoerythrin-labeled digoxigenin (left) vs. its immunocomplex (right)).

FIG. 11 is a diagram of the optical set-up for single-molecule spectroscopy, in which “PH1” and “PH2” are pinholes, “S” is a mechanical shutter, “L” is a lens in line with various focusing mirrors (represented by lines), “C” is the microchannel, “O” is the microscope objective, “TG” is the transmission grating, and “CCD” is the camera.

FIG. 12 is a set of images of the complete separation (A) and partial separation (B) of the zero-order images and first-order spectra generated during high-throughput single-molecule spectroscopy of YOYO-1-labeled λDNA.

FIG. 13 is a set of images of the single-molecule spectra of YOYO-1-labeled λDNA (A), POPO-III-labeled λDNA (B), YOYO-I and POPO-III mix-labeled λDNA (C), and a mixture of all three types of labeled λDNA (D).

FIG. 14 is a set of images of the single-molecule spectra of YOYO-I-labeled biotinylated 2.1 kb DNA (A), avidin conjugated R-phycoerythrin (B), conjugated DNA and R-phycoerythrin (C), and a mixture of conjugated DNA and R-phycoerythrin, YOYO-L-labeled 2.1 kb DNA (no biotin) and R-phycoerythrin (no avidin) (D).

### DETAILED DESCRIPTION OF THE INVENTION

The present invention provides methods and systems for distinguishing at least one molecule individually in a sample comprising multiple molecules and, thus, has a level of sensitivity (i.e., a targeted species can be recognized in an overwhelming excess of very similar molecules) and a detection limit appropriate for non-amplified samples. The throughput is substantially higher than detection by using hydrodynamic focusing, confocal microscopy or micro-droplets. The present invention offers advantages over currently available detection methods in that, in one embodiment, it enables imaging of at least about 200 molecules every 10 milliseconds and, in another embodiment, it enables imaging of at least about 200 molecules every 0.10 milliseconds. In this regard, many distinct molecules can be observed synchronously and their individual electrophoretic mobilities and/or their spectroscopic characteristics can be determined. By enabling many molecules to be analyzed simultaneously, the analysis time decreases linearly with the number of molecules observed. All existing electrophoretic separations and immunoassays can, in principle, be adapted for use in the context of the present invention. Electrophoretic separations enable analysis of the size, charge and hydrodynamic radius of DNA or protein as determined by migration velocity. Given that electrophoretic mobility and the molecular spectrum are inherent properties of the molecule being analyzed, they result in a more accurate measurement than measurement of only the fluorescence intensity of a molecule labeled with dye, for example. The present invention is most appropriately applied to samples that are extremely limited in size and concentration or samples in which unique components that need to be quantified would otherwise be masked. Thus, the present invention enables screening single copies of DNA or proteins within single biological cells for disease markers without performing PCR or other biological amplification and the assessment of the effects of low numbers of mutations. Single molecule assays are better for quantitation than enzyme-linked assays or PCR assays, commercial embodiments of which require comparison of the colors of different dilutions of the sample with standards, which can only be semi-quantitative, not to mention the fact that PCR is not a reliable quantitative tool inasmuch as amplification is exponential and the gain depends critically on temperature, solution composition, enzyme activity; etc. Amplification associated with such methods is subject to many interferences, such as temperature, matrix variations and enzyme integrity. Amplification also takes time. The present invention is suitable for high-speed, high-throughput, low-cost practical applications and facilitates clinical diagnosis.

In view of the above, the present invention provides a high-throughput method of distinguishing at least one molecule individually in a sample comprising multiple molecules. The method is “high-throughput” in that it allows the simultaneous analysis of multiple molecules in a given sample. In one embodiment (referred to herein as “first embodimenf”), the method comprises:

(i) subjecting a sample comprising multiple molecules, at least one molecule of which is detectably labeled, to electrophoresis,

(ii) imaging the electrophoretic mobility of each detectably labeled molecule over time by detecting the position of the detectable label of each detectably labeled molecule over time and, optionally, at the same time, dispersing the imaging by a transmission grating for spectroscopic analysis, and

(iii) determining the electrophoretic mobility of each detectably labeled molecule and, optionally, determining the molecular spectrum of each detectably labeled molecule.

In another embodiment (referred to herein as “second embodiment”), the method comprises:

(i) introducing a sample comprising multiple molecules in free solution, at least one molecule of which is detectably labeled, into a sample channel,

(ii) simultaneously imaging the position of each detectably labeled molecule, by detecting the position of the detectable label of each detectably labeled molecule, and dispersing the imaging by a transmission grating for spectroscopic analysis, and

(iii) determining the molecular spectrum of each detectably labeled molecule, thereby distinguishing at least one molecule individually in a sample comprising multiple molecules.

The methods enable at least one molecule to be distinguished individually in a sample comprising multiple molecules. “Multiple molecules” includes small molecules, nucleic acids (e.g., single-stranded, double-stranded, DNA, RNA, and hybrids thereof) and proteins (e.g., peptides, polypeptides and proteins). In this regard, a sample comprising multiple molecules can comprise multiple small molecules, multiple molecules of nucleic acids, multiple molecules of proteins or various combinations of the foregoing. Thus, a nucleic acid, small molecule or protein in a sample comprising (i) nucleic acids, small molecules or proteins, (ii) nucleic acids and small molecules, (iii) nucleic acids and proteins, (iv) proteins and small molecules, or (v) nucleic acids, small molecules and proteins can be distinguished. The methods obviate the need to amplify the multiple molecules in the sample.

By “detectably labeled” is meant that the molecule is labeled with a means of detection. Any suitable means of detection can be used. Such means are known in the art. The only proviso is that the means of detection can be imaged in accordance with the present invention. Preferably, the means of detection is a fluorescent label. The labeling of a molecule with a means of detection is within the ordinary skill in the art. In the context of the present invention, “detectably labeled” will be used to encompass molecules that are naturally detectable, such that they do not need to be labeled with a detection means. For example, certain nucleic acids and proteins can fluoresce under certain conditions.

In the first embodiment, the sample is subjected to electrophoresis, such as by placing the sample in an electrophoretic sample channel as described herein below. As indicated above, any electrophoretic separation technique and immunoassay technique can be, in principle, adapted for use in the context of the present invention. The electrophoretic mobility of each detectably labeled molecule is imaged over time so as to enable the determination of the electrophoretic mobility of each detectably labeled molecule. Based on the determination of the electrophoretic mobility of each detectably labeled molecule, individual molecules in a sample comprising multiple molecules can be distinguished. By enlarging the imaged area, expanding the laser beam and increasing the laser intensity, tens of thousands of molecules can be screened every second with the appropriate automatic image analysis software.

In the second embodiment, the sample is introduced into a sample channel. Any suitable method of introducing the sample into the sample channel can be employed. Preferred methods include electrophoresis and hydrodynamic methods, such as pressure and gravity. The position of each detectably labeled molecule is imaged by detecting the position of the detectable label of each detectably labeled molecule and, simultaneously, the image is dispersed by a transmission grating for spectroscopic analysis. Based on the determination of the molecular spectrum of each detectably labeled molecule, at least one molecule is individually distinguished in a sample comprising multiple molecules.

The at least one detectably labeled molecule can be a nucleic acid. The nucleic acid can be as short as 30 bp, and perhaps even shorter, provided that the nucleic acid is labeled with at least one detectable label. Preferably, the nucleic acid is detectably labeled with a fluorescent label. Preferably, the fluorescent label is an intercalating dye. Preferably, the intercalating dye is selected from the group consisting of Picogreen, POPO-III, TOTO-1 and YOYO-1, all of which are excitable at 488 nm. An especially preferred intercalating dye is YOYO-1. Preferably, at least one molecule of intercalating dye is present per 5 base pairs.

When equimolar (200 pM) solutions of dye-labeled λDNA (1 dye: 5 bp) were prepared and allowed to equilibrate for 2 hr, Picogreen-labeled DNA had the highest integrated intensity, followed by YOYO-1, TOTO-1 and POPO-III, with relative emissions of 0.565, 0.089 and 0.002, respectively. When the average single-molecule emission intensities for dye-labeled λDNA (50-500 fM) were compared, YOYO-1-labeled DNA had the highest average single-molecule peak intensity. This evidences that dye affinity is critical when working with femtomolar solutions of DNA. The relative molar fluorescence intensity at high DNA:dye concentrations cannot be extended to lower concentrations because of a shift in the chemical equilibrium, which favors dissociation.

Alternatively, the at least one detectably labeled molecule is a protein. Preferably, the protein is detectably labeled with a fluorescent label. Preferably, the fluorescent label is β-phycoerythrin.

Desirably, the sample comprises a buffer. While any suitable buffer can be used, desirably the buffer has low fluorescence background, is inert to the detectably labeled molecule, can maintain the working pH and, with respect to the first embodiment of the method, has suitable ionic strength for electrophoresis. The buffer concentration can be any suitable concentration, such as in the range from 1-100 mM. Preferably, the buffer is selected from the group consisting of Gly-Gly, bicine, tricine and amp. An especially preferred buffer is Gly-Gly. When the detectable label is fluorescent, desirably the buffer is photobleached.

The buffer desirably further comprises a sieving matrix for use in the first embodiment of the method. While any suitable sieving matrix can be used, desirably the sieving matrix has low fluorescence background and can interact specifically with the detectably labeled molecule to provide size-dependent retardation. The sieving matrix can be present in any suitable concentration; from about 0.5% to about 10% is preferred. Similarly, a sieving matrix of any suitable molecular weight can be used; from about 100,000 to about 10 million is preferred. Preferably, the sieving matrix is selected from the group consisting of poly(ethylene oxide) (PEO), poly(vinylpyrrolidine) (PVP), and hydroxyethylcellulose (HEC), all of which are readily soluble in water and have exceptionally low viscosity in dilute concentration (0.3% wt/vol). In addition, these polymer solutions are all below their entanglement threshold and are easy to prepare, filter and fill into capillary tubes. HEC and PEO in specific molecular weight and concentration ranges separate large DNAs with similar resolutions (see Table 1). PVP is not as good. However, when PEO is used as a coating material, it is not stable at pH 8.2, and HEC cannot be used as a coating material. PVP is a good coating material for capillary walls and can substantially suppress EOF (see, e.g., Gao et al., Anal. Chem. 70: 1382-1388 (1998)). With the pretreatment of PVP, a fused-silica capillary can perform like a coated capillary with electrophoretic mobility dominating the movement of the analytes. While a slight improvement in resolution can be realized by increasing the concentration of HEC in TBE buffer, the fluorescent background increases. Large molecular weight PEO polymers (Mᵣ=1,000,000 and Mᵣ=8,000,000) and small PEO (Mᵣ=100,000) polymers yield poor resolution, while medium-sized PEO polymers (Mᵣ=600,000) yield the highest resolution. A 50 mM solution of Gly-Gly (pH 8.2) with 0.3% PEO (Mᵣ=600,000) was found to provide the highest efficiency separation with the lowest fluorescence background. Finally, this matrix yields a typical separation resolution of 20-30% (absolute mobility) for the size range of 2000-48,502 bp with ˜1-3% RSD. In view of the foregoing, an especially preferred sieving matrix is PEO, in particular PEO having an Mᵣ of around 600,000.

TABLE 1
Observed mobilities (cm²/Vs) of DNA fragments in capillary
electrophoresis (CE) at an electric field strength of 200 V/cm

| | | λ | Mobility |
|---|---|---|---|
| | 2 kb DNA | λDNA mobility | difference |
| Separation buffer | (μ₁) | (μ₂) | (μ₁ − μ₂)/μ₂ |
| 0.1 × TBE, 0.3% PVP | 3.43 × 10⁻⁴ | 3.21 × 10⁻⁴ | 6.8% |
| (Mᵣ = 1,000,000) | | | |
| 0.5 × TBE, 0.3% HEC | 1.63 × 10⁻⁴ | 1.36 × 10⁻⁴ | 20% |
| (Mᵣ = 250,000) | | | |
| 50 mM Gly-Gly, 0.3% PEO | 2.00 × 10⁻⁴ | 1.61 × 10⁻⁴ | 24% |
| (Mᵣ = 600,000) | | | |

If the detectable label is fluorescent, desirably it is one that is induced to fluoresce with a laser, in which case a laser is used to induce the fluorescent label to fluoresce. A preferred laser is an argon ion laser. The argon ion laser is preferably operated at 488 nm for detection of fluorescently labeled nucleic acid and at 543 nm for detection of fluorescently labeled protein. The laser is focused at normal incidence to the sample. A lens, such as a lens having a focal length of 1.5 inch, can be used to focus the laser. If the laser generates extraneous light, an equilateral prism and at least one optical pinhole can be positioned before the imaging means and used to eliminate the extraneous light. The positioning of the equilateral prism and the optical pinhole is within the ordinary skill in the art and is exemplified in the Examples set forth herein.

The fluorescence from the fluorescent label is focused on an imaging means. Any suitable imaging means can be used. Preferably, the imaging means is an intensified CCD camera. The fluorescence from the fluorescent label can be focused on the imaging means by a microscope objective, such as a microscope objective of 10× power.

One or more optical filters can be positioned in front of the imaging means. The one or more optical filters can comprise one or two holographic notch filters. The one or two holographic notch filter can consist of two 488 nm holographic notch filters with an optical density of >6 for detection of fluorescently labeled nucleic acid. The one or more optical filters can further comprise a wide-band interference filter.

The electrophoretic mobility can be measured by any suitable method. Examples of suitable methods include the multiframe method, the streak method and the multispot method. Using the multiframe method, the electrophoretic mobility of each molecule is determined by first calculating the distance it moves (cm) per unit time (see) and then dividing that by the applied voltage. Electrophoretic mobility of each molecule is determined in the streak method by calculating the length of the streaks and then dividing by the applied voltage. By calculating the spacing between spots and then dividing by the applied voltage, the electrophoretic mobility of each molecule is determined in the multi-spot method.

The multiframe method involves the assembly of information from a series of consecutive images, i.e., frames, generated by the imaging means. Each frame contains a snapshot of all of the molecules in the field of view. Using a frame rate of 15-20 Hz, for example, the motion of each molecule is tracked by viewing the frames sequentially. The total migration time and distance are measured for each molecule and, along with the electric field strength, are used to determine the single-molecule mobility as exemplified in the Examples. One requirement for using the multiframe method is that one must be able to correlate spots in consecutive frames as belonging to specific molecules. Since the measurements involve more than one image, the ability to store a large amount of raw data is also critical. Also, the laser pulse should be kept short compared to molecular diffusion times (Xu et al., Science 276: 1106-1109 (1997)) to create a well-defined spot in the image.

The streak method involves the use of one frame to determine the electrophoretic mobility of a detectably labeled molecule. The detectably labeled molecule moves relative to the imaging means and its trajectory is tracked as a streak due to a long laser burst. The length of the exposure time and the electric field strength determine the electrophoretic mobility of the detectably labeled molecule. The electrophoretic mobility of each detectably labeled molecule is determined from the number of pixels in its streak as exemplified in the Examples.

The multi-spot method also involves the use of one frame to determine the electrophoretic mobility of a detectably labeled molecule; the difference is that, while the detectably labeled molecule moves relative to the imaging means, its trajectory is tracked as a series of dots in the frame as opposed to a streak due to a series of short laser bursts. The electrophoretic mobility of each detectably labeled molecule is determined from the distance between the first and last visible spots, the total number of spots, the laser burst rate and the applied electric field strength as exemplified in the Examples.

In the first embodiment of the method, the electrophoretic mobility of a detectably labeled molecule, which is preferably present in a sample at a concentration of at least about 1 copy per milliliter, is preferably imaged in as short of time as possible. Preferably, the electrophoretic mobility is imaged in less than about 5 milliseconds. In the second embodiment of the method, the position of the detectably labeled molecule, which is preferably present in a sample at a concentration of at least about 1 copy per milliliter, is also preferably imaged in as short of time as possible. Preferably, the position of the detectably labeled molecule is imaged in less than about 0.05 milliseconds.

In the first embodiment of the method, preferably, at least about 200 detectably labeled molecules are imaged every 10 milliseconds; more preferably, at least about 2,500 detectably labeled molecules are imaged every 25 milliseconds. In the second embodiment of the method, preferably, at least about 200 detectably labeled molecules are imaged every 0.10 milliseconds; more preferably, at least about 2,500 detectably labeled molecules are imaged every 0.25 milliseconds.

The data collected in accordance with the present inventive method can be analyzed by hand. Preferably, the data are analyzed using software such that as high a throughput as possible can be realized. Software for use in the present inventive method is available from Dr. E. Yeung, Iowa State University, Ames, Iowa.

In addition to the above method, the present invention provides systems for use in the two embodiments of the above method. The system for use in the first embodiment of the method comprises:

(i) an electrophoretic sample channel, into which is introduced a sample comprising multiple molecules, at least one molecule of which is detectably labeled with a fluorescent label,

(ii) a light source comprising or consisting essentially of at least one wavelength of light that causes at least one molecule in the sample comprising multiple molecules that is detectably labeled with a fluorescent label to fluoresce, wherein the light source irradiates the electrophoretic sample channel,

(iii) an imaging means, wherein the imaging means images the electrophoretic mobility of each detectably labeled molecule in the sample over time, and, optionally,

(iv) a transmission grating, which disperses the imaging of the electrophoretic mobility of each detectably labeled molecule in the sample.

The system for use in the second embodiment of the method comprises:

(i) a sample channel, into which is introduced a sample comprising multiple molecules in free solution, at least one molecule of which is detectably labeled with a fluorescent label,

(ii) a light source comprising or consisting essentially of at least one wavelength of light that causes at least one molecule in said sample comprising multiple molecules that is detectably labeled with a fluorescent label to fluoresce, wherein said light source irradiates said sample channel,

(iii) an imaging means, wherein said imaging means images the position of each detectably labeled molecule in said sample, and,

(iv) a transmission grating, which simultaneously disperses the imaging of the position of each detectably labeled molecule in said sample.

Any suitable electrophoretic sample channel can be used in the first embodiment of the method. Similarly, any suitable sample channel can be used in the second embodiment of the method. Desirably, the sample channel is sufficiently small as to be conducive to single molecule detection and distinction in a sample comprising multiple molecules and is suitable for subjecting a sample contained within the sample channel to electrophoresis (for first or second embodiment) or hydrodynamic methods of sample introduction, such as pressure and gravity (for second embodiment). Also desirably, the sample channel allows the passage of light from the light source through the wall of the sample channel facing the light source to the sample in the sample channel. Thus, the walls of the sample channel are desirably transparent, although, in some instances, the walls of the sample channel can be translucent. In this regard, it is not necessary for the entirety of the walls of the sample channel to allow the passage of light from the light source as described above as long as at least a portion of the walls of the sample channel allow the passage of light from the light source such that the sample in the sample channel is irradiated and fluorescence can be detected by the imaging means. A preferred sample channel is a capillary tube.

In general, the sample channel should have smooth surfaces and uniformly thick walls and be made of a material that is transparent over the range of wavelengths of light that cause the detectably labeled molecule to fluoresce. Preferred materials for the sample channel include, but are not limited to, quartz, fused silica and glass. The cross-section of the sample channel is not critical. Similarly, the thickness of the sample channel is not critical. The wall should be of sufficient thickness so as to maintain the structural integrity of the container, yet not so thick as to impede adversely the passage of light through the channel. The shape of the sample channel also is not critical; the sample channel can have any suitable shape.

A capillary tube is a preferred sample channel. Capillary tubes are commercially available from a number of sources, including Polymicro Technologies, Inc., Phoenix, Ariz. The capillary tube is preferably coated with a polymer, such as polyimide, that is mechanically stable. The coating must be removed in the region to be irradiated by the light source. An excimer laser can be used to remove the polymer coating.

The light source preferably is a laser, such as an argon ion laser. Preferably, the argon ion laser is operated at 488 nm for detection of fluorescently labeled nucleic acid and at 543 nm for detection of fluorescently labeled protein. The light source, such as the laser, preferably is focused at normal incidence to the sample. Preferably, the system further comprises a lens between the light source and the sample channel, wherein the lens focuses the light, such as laser light, at normal incidence to the sample channel. The lens preferably has a focal length of 1.5 inch. If the laser generates extraneous light, the system further comprises an equilateral prism and at least one optical pinhole before the imaging means to eliminate the extraneous light from impinging on the imaging means.

The imaging means can be any suitable imaging means. Preferably, the imaging means is an intensified CCD camera. The system can further comprise a microscope objective, such as a microscope objective of 10× power, between the sample channel and the imaging means; the microscope objective focuses the fluorescence from the fluorescent label onto the imaging means.

One or more optical filters can be positioned in front of the imaging means. The one or more optical filters preferably comprises one or two holographic notch filters. The one or two holographic notch filters preferably consist of two 488 nm holographic notch filters with an optical density of >6 for detection of fluorescently labeled nucleic acid. The one or more optical filters can further comprise a wide-band interference filter.

Transmission gratings are commercially available. A preferred transmission grating is described in the Examples.

In the system for use in the first embodiment of the method, the electrophoretic mobility of a detectably labeled molecule, which is preferably present in a sample at a concentration of at least about 1 copy per milliliter, is preferably imaged in as short of time as possible. Preferably, the electrophoretic mobility is imaged in less than about 5 milliseconds. In the system for use in the second embodiment of the method, the position of the detectably labeled molecule, which is preferably present in a sample at a concentration of at least about 1 copy per milliliter, is preferably imaged in as short of time as possible. Preferably, the position of the detectably labeled molecule is imaged in less than about 0.05 milliseconds.

In the system for use in the first embodiment of the method, preferably, at least about 200 detectably labeled molecules are imaged every 10 milliseconds. More preferably, at least about 2,500 detectably labeled molecules are imaged every 25 milliseconds. In the system for use in the second embodiment of the method, preferably, at least about 200 detectably labeled molecules are imaged every 0.10 milliseconds. More, preferably at least about 2,500 detectably labeled molecules are imaged every 0.25 milliseconds.

### EXAMPLES

The following examples serve to illustrate the present invention and are not intended to limit its scope in any way.

### Example 1

The following example illustrates the use of the present invention to distinguish individual molecules of DNA in a sample comprising multiple molecules of DNA using fluorescence and electrophoresis.

Capillary Colunn Pre-Treatment and Running Buffers:

An aqueous solution of 50 mM Gly-Gly buffer (Sigma Chemical Co., St. Louis, Mo.) was prepared and adjusted to pH 8.2 with several drops of 1.0 N NaOH (Sigma). This buffer was used to prepare all samples and solutions. The running buffer solution was 0.3% (wt./vol.) 600,000 Mr PEO. Before addition and dissolution of the PEO polymer, the buffer was filtered through a 0.2-μm filter. The dissolution was brought about using a magnetic stir-bar and plate. An extremely slow stirring rate was used to prevent destruction of the polymer. The running buffer was further treated by application of ultraviolet light from a hand-held mercury lamp for approximately 12 hr, which reduced fluorescence from any impurities in the sample via photobleaching (Van Orden et al., Anal. Chem. 72: 37-41 (2000)). Glass capillaries (140 μm o.d., 30.5 μm i.d., and 12 μm coating) were obtained from Polymicro Technologies, Inc. For both imaging and bulk electrophoresis, the capillary columns were pre-treated for 10-30 min with 0.2-0.3% (wt./vol.) PVP 1,000,000 Mᵣ in the above-described Gly-Gly buffer.

DNA Samples:

All DNA samples were prepared in the photobleached Gly-Gly buffer described above. DNA samples were labeled with YOYO-1 intercalator dye (Molecular Probes, Eugene, Oreg.) at a ratio of 1 dye molecule per 5 bp. In general, DNA samples were in the concentration range of 50-200 pM. For the single-molecule electrophoresis experiments, these DNA samples were further diluted to 0.1-0.7 μM just prior to the start of the experiment. The appropriate volume of YOYO-1 dye was dissolved in the Gly-Gly buffer before addition of the DNA to prevent precipitation and to promote uniform labeling. Dye/DNA samples were allowed to incubate for about 2 hr before further dilution and use. Lambda DNA (48,502 bp) was obtained from Molecular Probes. The other DNA sample (2,000 bp) was made using a standard PCR protocol. The 2000 bp product was verified by slab-gel electrophoresis in comparison with Lambda DNA/Hind III digest on 1.2% (wt./wt.) agarose visualized using ethidium bromide. The product was then isolated using a 1% agarose slab gel. The band was removed from the gel using a spin-column at 8,000 rpm for 8 min followed with two aqueous washes. DNA concentration was measured using standard UV absorbance methods.

Bulk Capillary Electrophoresis:

Capillary electrophoresis with laser-induced fluorescence (LIF) detection was used to determine the electrophoretic mobility of the DNA samples described above. Briefly, a high-voltage power supply (Glassman High Voltage Inc., Whitehouse Station, N.J., EH series 0-30 kV) was used to drive electrophoresis. The capillary had a 50 cm total length with 30 cm from the injection end to the detector. The excitation source was an argon-ion laser (488 nm, Uniphase, San Jose, Calif., model 2213-75SLYW). The fluorescent signal from the photomultiplier tube (PMT) was directly converted to voltage by a 10 kΩ resistor then passed to an A/D converter. The voltage was sampled at 4 Hz and stored on a computer. A 500-550 nm band-pass filter (Oriel Instruments, Stamford, Conn.) was used to eliminate scattered laser light from entering the detector. After pre-treating the capillary with PVP (see above), the column was rinsed with the running buffer. A potential of 10 kV was applied to the capillary for a period of 10 min so that the capillary could reach equilibrium. The sample was injected with electrokinetic injection for 3 s at 200 V/cm. The running voltage for the separation was set at 80 V/cm. Between runs, the capillary was rinsed with the PVP solution and the running buffer, respectively.

Single-Molecule Electrophoresis Capillary Holder and Sample Stage:

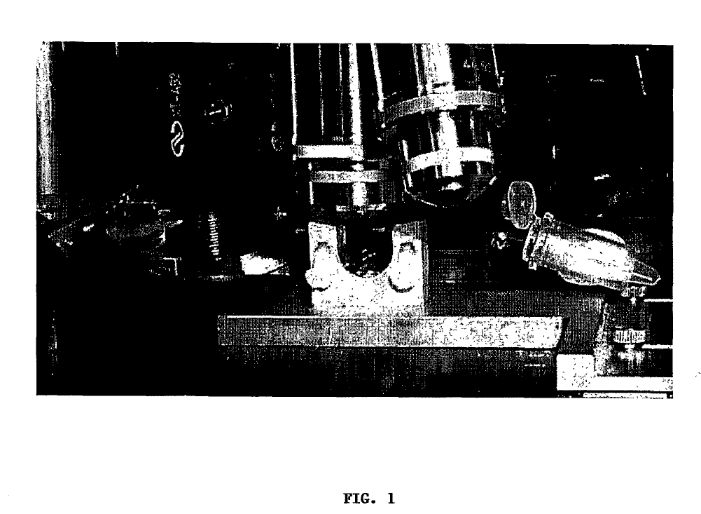

A 16 cm long capillary was used for all experiments with a 1 cm window cleared at 5.5-6.5 cm. The window was created by thermally vaporizing the polymer cladding in an electronically heated metal coil. The window was then washed repeatedly with methanol-soaked lens cleaning paper before use. Larger o.d. capillaries (1 cm long) were glued to the sections of sample capillary adjacent to the window. These larger sections of capillary were inserted into an aluminum block and held in place with plastic set-screws. This configuration, as shown in FIG. 1, provided a sturdy platform, which allowed sample changes without the need for re-alignment. One end of the capillary was glued into a 25 G syringe needle to facilitate filling the narrow o.d. capillary. The capillary was filled with the appropriate solution and the ends were inserted into plastic centrifuge tubes as reservoirs. Chromel wire was used as electrode material. The electrodes were connected to an in-house built −1250 V D.C. power supply.

Microscope and ICCD Camera:

A Pentamax 512-EFT/1EIA intensified CCD (ICCD, Princeton Instruments, Princeton, N.J.) camera was mounted on top of a Zeiss Axioskop upright microscope. The digitization rate of the camera was 5 MHz (12 bits) with software controller gain set at 3 and hardware intensifier gain set at 10. The camera was operated in the external synchronous mode with the intensifier-disabled open. The camera was also in the frame-transfer mode. The excitation source was a Coherent Innova-90 argon ion laser operated at 488 nm. Extraneous light from the laser was eliminated with the aid of an equilateral prism and an optical pin-hole. The laser beam was focussed at normal incidence to the capillary with a 1.5-inch focal-length lens. The microscope objective used was a Zeiss 10× Fluar (0.5 n.a.). Two 488-nm holographic notch filters (Kaiser Optical, HNFP) with optical density of >6 and one wide-band interference filter were used between the objective and the ICCD. The notch filters were used to eliminate laser scattered from the capillary walls and the interference filter was used to eliminate Raman scatter from water.

Single-Molecule Electrophoresis Timing:

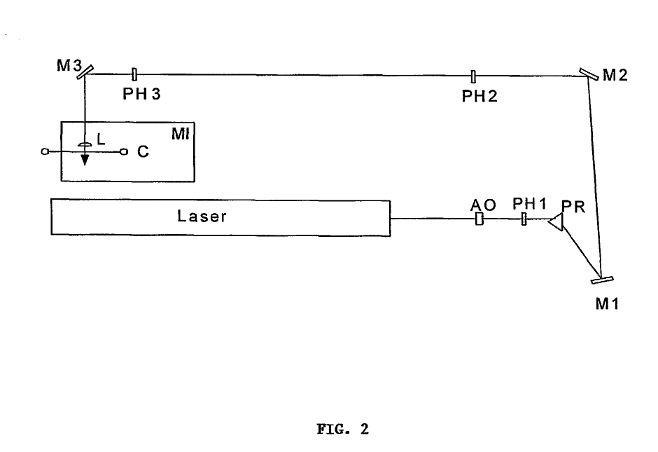

The experimental timing was controlled with a Stanford Research Systems Model DG535 Four-Channel Digital Delay/Pulse Generator. The ICCD camera was triggered at time=0 ms with a 5 ms duration TTL pulse. An Isomet Model 1205 acousto-optic modulator was used as a shutter. The first order dispersion was used as the source for the experiments and the digital delay generator was used to control laser pulse duration and frequency with respect to the ICCD camera integration time. The optical arrangement is shown in FIG. 2, in which “Laser” is a Coherent Innova 90 Argon Ion laser, “AO” is an Isomet Model 1205c Acousto-Optic Modulator, “PH1” is a pinhole section of 1^{st} order diffracted beam, “PR” is an equilateral prism, “M1,” “M2” and “M3” represent steering mirrors, “PH2” and “PH3” represent laser alignment pinholes, “L” is an f=1” plano-convex lens, “C” is a capillary and holder, and “MI” is a microscope.

The camera integration time (software-controlled) was estimated to be delayed ˜3 ms from the initial edge of the trigger pulse. The laser pulse onset, in all cases, began at time=+5 ms relative to the start of the trigger to the ICCD. Therefore, ˜2 ms of dead time is present in each data frame.

Multi-Frame Method:

A running voltage of −78.1 V/cm was applied to the capillary in the horizontal direction, which caused the DNA molecules to migrate in that direction. The cursor in each frame was held in the same position in real space so that the horizontal motion was apparent. The ICCD camera exposure frequency was 20 Hz with an exposure time of 10 ms for each frame. The laser pulse time was 3 ms with an average power of 4 mW. Each frame consisted of 106 (horizontal)×91 (vertical) square pixels. Each pixel represents 1.25×1.25 μm of real space. The electrophoretic mobility of each molecule was determined by first calculating the distance it moves (cm) per unit time (s) and then dividing that by the applied voltage.

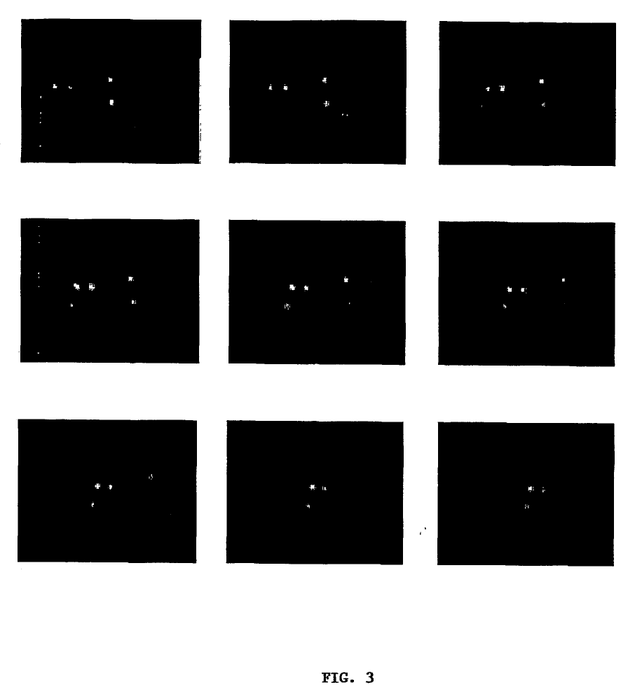

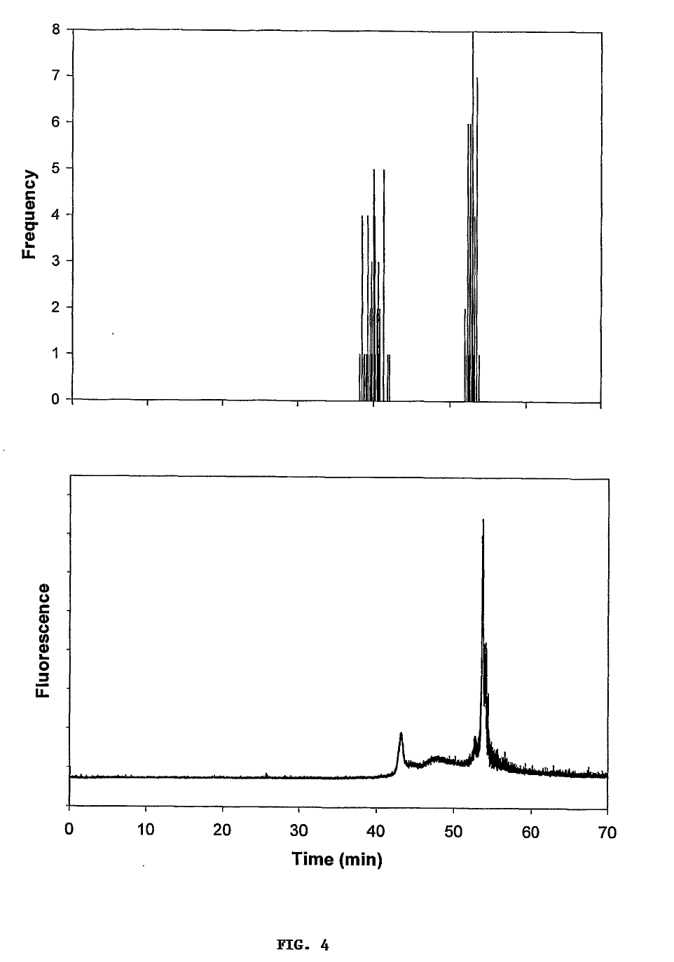

The multi-frame method assembled information from a series of consecutive images as shown in FIG. 3, which is a sequence of nine consecutive images, read left to right and top to bottom, of five separate λDNA molecules (48,502 bp each) labeled with YOYO-1 and analyzed in accordance with the multi-frame method. Each frame was a snap-shot (3 ms) of all molecules within the field of view (30 micrometers wide and 100 micrometers long). A high frame rate (15-20 Hz) was used to track the molecular motion. This “movie” was used to follow the motion of each molecule through several consecutive frames. The total migration time and excursion distance of each molecule combined with the field strength yielded the single-molecule mobility. With this method, many molecules can be tracked and characterized simultaneously. A similar experiment was performed on the 2 kb DNA. The mobility was recorded for 50 molecules from each data-set. The calculated mobility for the five λDNA molecules was 1.46E-04 cm²/V/s. The calculated mobility for the 2 kb DNA molecules was 2.09E-04 cm²/V/s. The relative standard deviations for these experiments was 1.0 and 3.1% respectively, which is better than intensity-based measurements (Van Orden et al. (2000), supra). The results agree well with those determined from standard capillary electrophoresis (Table 1 and FIG. 4, which is a comparison of a bulk electropherogram (bottom panel, fluorescence vs. time (min)) with a histogram (top panel, frequency vs. time (min)) of migration times predicted from the single-molecule mobilities based on the DNA assay results of 2 kb vs. 48.5 kb. It is, therefore, possible to distinguish 2 kb DNA from 50 kb DNA based on electrophoresis at the single molecule level with almost no ambiguity.

Although the experimental conditions were chosen to display only a few molecules per image for the sake of clarity, a substantially higher density of spots can be accommodated to increase the data throughput. In FIG. 3, for example, as many as 5×10 molecules can fit into the subframe. If the full 512×512 CCD frame is used to image a larger area, 1250 molecules can be screened in 50 ms. Another factor of 10-50 increase in throughput is expected if higher electric fields, faster frame rates and higher laser powers are employed. The construction of a wider but thinner flow channel and synchronization of the applied voltage with the frame rate will guarantee that 100% of the molecules are characterized.

Streak Method:

A running voltage of −78.1 V/cm was applied to the capillary in the horizontal direction, which caused the DNA molecules to migrate in that direction. The ICCD camera exposure frequency for this sequence was 4 Hz with a 210 ms exposure time. Each frame consists of 106 (horizontal)×91 (vertical) square pixels. Each pixel represents 1.25×1.25 μm. The electrophoretic mobility of each molecule was determined by first calculating the length of the streaks and then dividing by the applied voltage. The mobilities for these molecules were determined from the number of pixels in the streak.

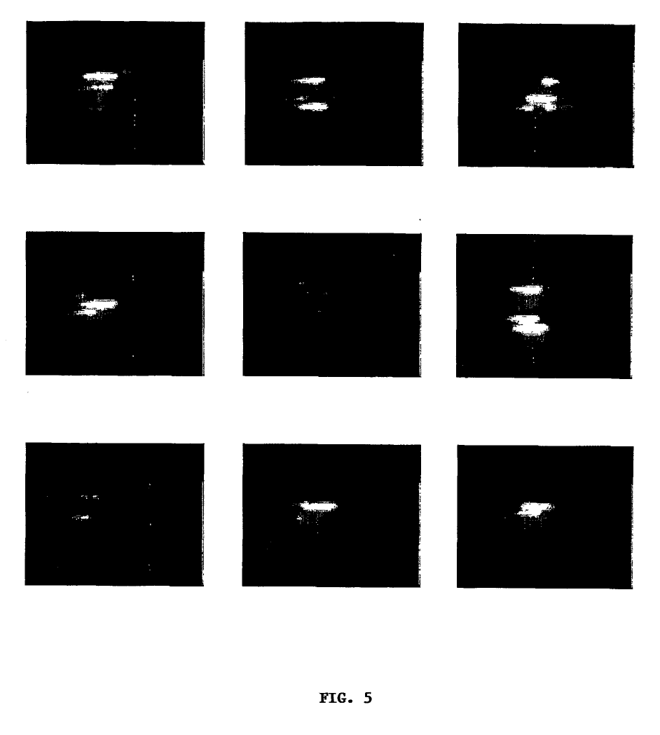

The streak method uses both long exposure time (low frame rate) and long laser burst time as shown in FIG. 5, which is a sequence of nine consecutive images, read left to right and top to bottom, of several separate XDNA molecules (48,502 bp each) labeled with YOYO-1 and analyzed in accordance with the streak method. Since the molecules are moving relative to the camera during exposure, the trajectories show up as streaks in the image. From the physical length of the streak, the exposure time and the field strength, the mobility can be determined from just one of the frames. Faster molecules leave a longer streak and slower molecules leave a shorter streak so that data analysis is straightforward. The streak length is then used as a determinate in assigning the molecular identity. Correlation in-between frames is not needed here. However, a requirement is that the entire streak must be within the field of view and the molecule does not go out of focus or otherwise become photobleached during each exposure. The S/N ratio is also lower than in the multi-frame method and photobleaching is more likely because longer total exposure times are used. Actual determination of mobilities using this method yields large variances, implying that photobleaching is important.

Multi-Spot Method:

A running voltage of −78.1 V/cm was applied to the capillary in the horizontal direction, which caused the DNA molecules to migrate in that direction. The ICCD camera exposure frequency for this sequence was 2 Hz with an exposure time of 420 ms for each frame. The laser pulse frequency was 20 Hz with 3 ms long pulse duration. Each frame consists of 106 (horizontal)×91 (vertical) square pixels. Each pixel represents 1.25×1.25 μm of real space. The electrophoretic mobility of each molecule is determined by first calculating the spacing between spots and then dividing by the applied voltage. The calculated mobility for this data set is 1.49E-04 cm²/V/s. The relative standard deviation for such an experiment is typically in the range of 1-3%.

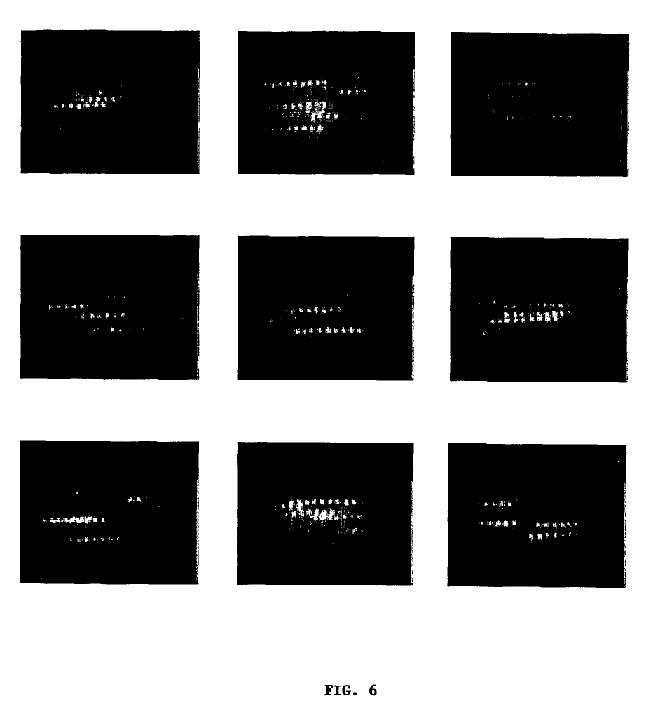

The multi-spot method differs in that a relatively long exposure time is used in conjunction with short bursts of laser light as shown in FIG. 6, which is a sequence of nine consecutive images, read left to right and top to bottom, of several separate λDNA molecules (48,502 bp each) labeled with YOYO-l and analyzed in accordance with the multi-spot method. Typically, 275 ms ICCD camera exposure time is used with 3 ms laser shots at 15-20 Hz. The resulting image consists of linear groupings of spots within one image from each molecule. Assigning groups of spots to individual molecules is also trivial, as seen in several closely packed series of spots in FIG. 6. The mobility is measured by determining the distance between the first and the last visible spot and combining this with the number of spots, the burst rate of the laser, and the applied field strength. This method is advantageous because mobilities can be measured from each frame even if only a few spots per molecule are recorded due to photobleaching, focusing, or the physical location of the molecule. In addition, molecules can be viewed side by side and a qualitative determination of mobility can be used to identify the component molecule. In a mixed sample of two DNA molecules (one fast and one slow), the identity can be determined immediately. One disadvantage of this method is that the S/N is worse than the multi-frame method, due to the longer total irradiation time. However, S/N is better than the streak method because the sample is not continuously irradiated during a given exposure. An important feature in FIG. 6 is that the intensities among the groups of spots show large variations. Even for a given molecule, the intensity varies considerably along its length. This confirms the need for uniform excitation and constant transit times for intensity-based DNA sizing (Castro et al., Anal. Chem. 65: 849-852 (1993); Petty et al., Anal. Chem. 67: 1755-1761 (1995); Chou et al., PNAS USA 96: 11-13 (1999); and Van Orden et al. (2000), supra) and the lack of such interference in electrophoresis-based measurements.

### Example 2

The following example illustrates the use of the present invention to distinguish individual molecules of protein in a sample comprising multiple molecules of protein using immunoassay.

Fused-silica capillaries (cylindrical 140 μm o.d. and 30 μm i.d. for DNA, square 350 μm outside and 75 μm inside for protein) were obtained from Polymicro Technologies. For both imaging and bulk electrophoresis, the capillary columns were pre-treated for 10-30 min with 0.2-0.3% (wt./vol.) PVP 1,000,000 Mᵣ in Gly-Gly buffer. DNA samples (50-200 pM) were labeled with YOYO-1 intercalator dye (Molecular Probes) at a ratio of 1 dye molecule per 5 bp. These were further diluted to 0.1-0.7 μM just prior to the start of the experiment. Lambda DNA (48,502 bp) was obtained from Molecular Probes. The other DNA sample (2,000 bp) was made using a standard PCR protocol and verified by slab-gel electrophoresis on 1.2% (wt./wt.) agarose using ethidium bromide. Digoxigenin and its conjugates were prepared according to Chen et al., J. Chromatogr. A 680: 425-430 (1994)). Capillary electrophoresis with laser-induced fluorescence detection was used to determine the bulk electrophoretic mobilities. The capillary was 50 cm long with 30 cm from the injection end to the detector. The sample was electrokinetically injected for 3 s at 200 V/cm. The separation voltage for the separation was 80 V/cm. Between runs, the capillary was rinsed with the PVP solution and the running buffer. A 16-cm length was used for all single-molecule imaging experiments with a 1-cm window cleared at 5.5-6.5 cm. Larger o.d. capillaries (1 cm long) were glued to the sections of sample capillary adjacent to the window to provide a sturdy platform.

A Pentamax 512-EFT/1EIA intensified CCD (ICCD) camera was mounted on top of a Zeiss Axioskopt microscope with a 10× Fluar objective (0.5 n.a.). The digitization rate of the camera was 5 MHz with software controller gain set at 3 and hardware intensifier gain set at 10. The frame-transfer camera was operated in external synchronous mode with the intensifier disabled open. The laser beam was focused at normal incidence to the capillary with a 4-cm focal-length lens. Holographic notch filters (Kaiser Optical) with optical density of >6 and one wide-band interference filter were used between the objective and the ICCD. Timing was controlled with a Stanford Research Systems DG535 Digital Delay/Pulse Generator. An Isomet Model 1205 Acousto-optic Modulator was used as a shutter. The first order dispersion was used as the source for the experiments.

Blood samples were obtained from unidentified donors. The QLAamp DNA Blood Mini Kit (QIAGEN, Inc., Valencia, Calif.) was used to purify λDNA from platelets. In order to ensure that high quality DNA was obtained, λDTA alone was used as the anti-coagulant. The use of gel to separate platelet-rich plasma from blood was avoided, especially for 16.5 kb DNA. Centrifugation was performed at less than 100 g to separate platelet-rich plasma from blood. For the last step, pure water was used to dissolve the DNA sample. The 6.1 kb DNA was amplified from the mtDNA as template by PCR. A 50 mM solution of Gly-Gly (pH 8.2) with 0.3% PEO (600,000 Mr) was found to provide the highest efficiency separation with the lowest fluorescence background for kb-sized DNA fragments while a 0.3% PVP (1,000,000 Mr) solution in 50 mM Gly-Gly (pH 8.2) separated β-phycoerythrin-labeled digoxigenin (BP-D) from its immune complex (anti-D-BP-D). These conditions yield typical differences in absolute mobilities of 20-30% with 1-3% RSD.

The imaging configuration is a miniaturized version of the CE set-up. DNA or protein is driven through the capillary or microfabricated channel by an applied D.C. electric field. Fluorescence is induced with 1 mW of 488-nm or 543-nm excitation from a laser, respectively. The molecular trajectory is imaged in real-time through a micro-scope with the aid of an intensified-CCD camera. The purpose is not to separate the molecules, but to identify each one based on the measured electrophoretic mobility.

Binding affinity is critical when working with femtomolar solutions of DNA or proteins. The relative molar fluorescence intensity of high analyte:label concentrations cannot be immediately extended to lower concentrations because of chemical equilibrium, which favors dissociation. So YOYO-1 was chosen for DNA intercalation and covalently bonded BP was used for the antigen. For a moderate but not excessively large formation constant, K_{f}=[AB]/[A][B]=10¹² M, binding is essentially 100% efficient, i.e. [AB]/[B]=1, if the reagent concentration, [A], is at least 1 μM. In the DNA experiments, unreacted YOYO-1 is nonfluorescent and can be present in large excess, if necessary. In immunoassay, 1 pM is a comfortable level for fluorescence imaging. Detectability of the target reduces to the ability to count large total number of molecules before finding a bound molecule. A positive event every 1,000 counts will result from an antigen present at a 1 fM concentration. This is already 1,000× better than bulk immunoassays. The situation is actually more favorable than that, since kinetics, rather than bulk formation constants, govern single molecules. Single-molecule concentrations are not defined and once formed, the bound form is amenable to detection before it dissociates.

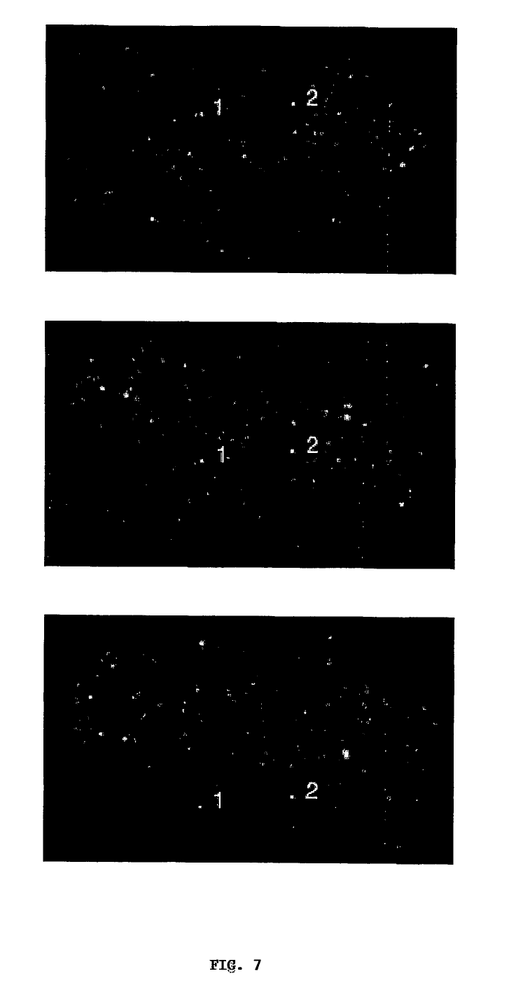

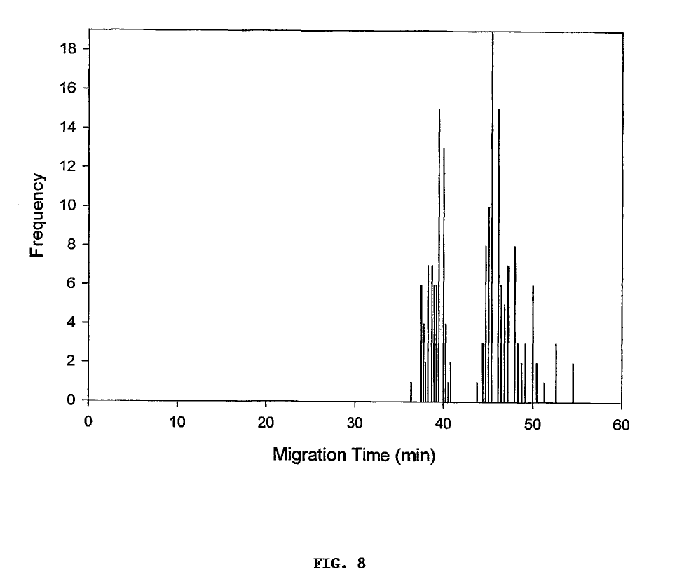

The multi-frame method was used to determine the electrophoretic mobilities of single molecules as shown in FIG. 7, which is a sequence of three consecutive images, read top to bottom, of a mixture of 16.5 kb and 6.1 kb fragments derived from human mtDNA, labeled with YOYO-1, and analyzed in accordance with the multi-frame method. As shown in FIG. 8, which is a histogram of frequency vs. migration time (mins) showing the predicted migration times in capillary electrophoresis obtained from single-molecule images for a mixture of 6.1 kb (left group) and 16.5 kb (right group) fragments derived from human mtDNA, the measured mobilities cluster into two distinct groups with no overlap. The relative numbers in each group are as expected from the fraction of each type of DNA in the mixture. FIG. 8 shows that single copies of mtDNA can be screened for rare occurrences of deletions without physical separation.

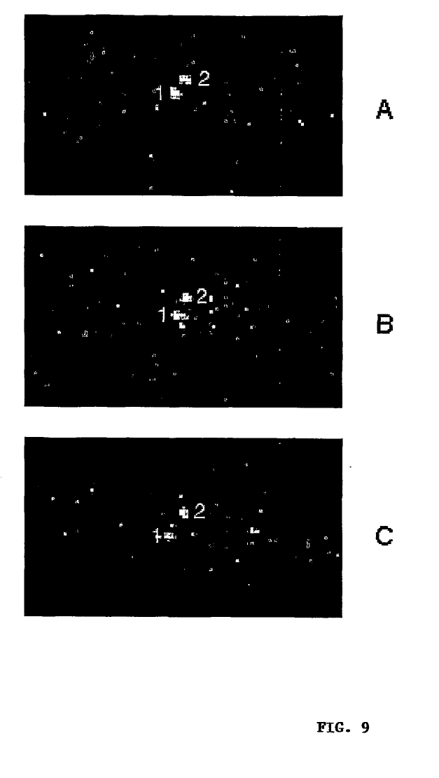

The universal applicability of this approach can be confirmed by an electrophoresis-based homogeneous immunoassay (see FIG. 9, which is a sequence of three consecutive images, read top to bottom, of β-phycoerythrin-labeled digoxigenin (1) and its immunocomplex (2) in capillary electrophoresis). β-Phycoerythrin is a suitable fluorescence label for single-molecule detection (Nguygen et al., Anal. Chem. 59: 2158-2161 (1987)). In a mixture of a digoxigenin and its immunocomplex, differential migration can be observed even without detailed data analysis.

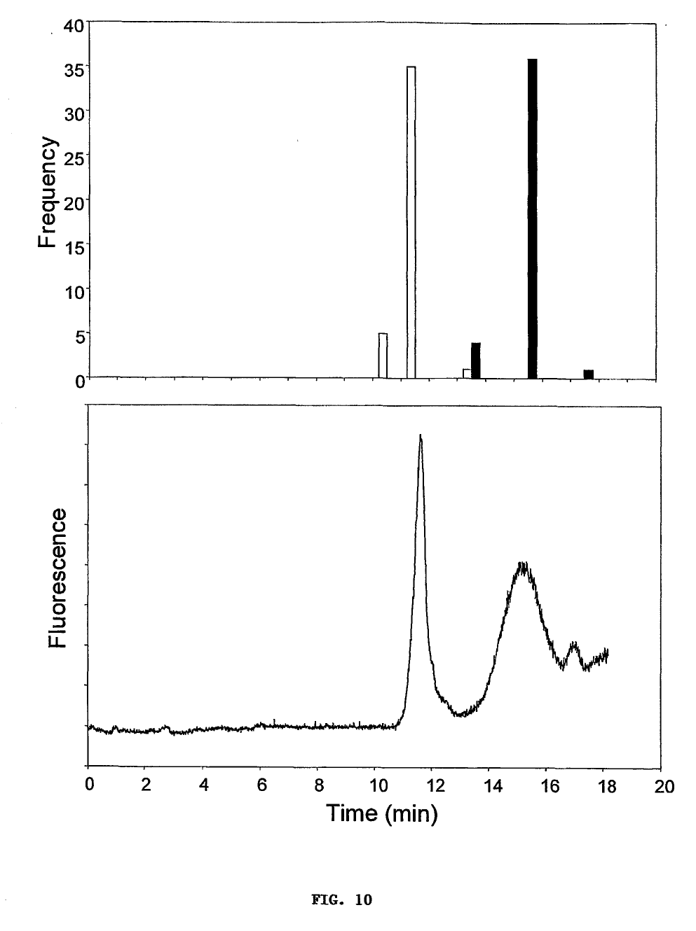

The precision of such mobility measurements depends on the total motion (number of discrete pixels counted). For the DNA experiments, 30 to 80 pixels of motion can be followed and the RSD is 1-3%. The histogram of migration times predicted from single-molecule mobilities follows the bulk CE results. Only 5-10 pixels were involved in sizing the proteins, but the precision of 5% is more than sufficient to distinguish the bound and unbound forms at a high confidence level (see FIG. 10, which is a comparison of a bulk electropherogram (bottom panel, fluorescence vs. time (min)) with a histogram (top panel, frequency vs. time (min)) of migration times predicted from the single-molecule mobilities based on the digoxin immunoassay results (β-phycoerythrin-labeled digoxigenin (left) vs. its immunocomplex (right)). The histogram of migration times predicted from single-molecule mobilities also follows the bulk CE results. The slight overlap in the two populations in FIG. 10 is due to heterogeneity in the labeling reaction. These results indicate that the present immunoassay detection scheme for HIV infection (Kalyanaraman et al., Science 225: 321-323 (1984); and Borkowsky et al., Lancet 1: 1168-1171 (1987)) can be scaled to the single-virus level by using a phycoerythrin-labeled anti-HIVp24-antibody or phycoerythrin-labeled HIVp24 antigen. A high concentration of the labeled antibody will guarantee efficient reaction even at a low concentration of the antigen, and vice versa.

The consecutive images were examined manually and the movements were tracked by counting the number of pixels traveled by each molecule over a known time interval. Cross-correlation of the sequences of images by multiplying them with each other after applying well-defined shifts in pixel number would enable automation. The rare event (e.g., bound complex or deleted DNA fragment) would then be highlighted in the resulting cross-correlation image while the normal events in large excess (e.g., probe molecule or intact DNA) would be suppressed. Data analysis would then be performed at rates comparable to data acquisition.

### Example 3

The following example illustrates the use of the present invention to distinguish individual molecules of DNA in a sample comprising multiple molecules of DNA using fluorescence, electrophoresis and spectroscopy.

Running Buffer.

A 50 mM aqueous solution of Gly-Gly (Sigma) was prepared and the pH was adjusted to 8.2 by drop-wise addition of 1 N NaOH (Sigma). This solution was filtered through a 0.2-μm filter and photobleached with a mercury lamp for 12 hr prior to use. This solution was used to prepare all samples and used as the running buffer in all experiments.

DNA Samples.

DNA samples were labeled with YOYO-1 or POPO-III dye (Molecular Probes) at a ratio of one dye molecule per five bp according to the manufacturer's instructions. DNA stock solutions were in the concentration range of 50-200 pM. Samples were allowed to incubate for about 1 hr before use. For single-molecule spectroscopy experiments, these DNA samples were filter diluted to 0.1-0.7 pM just prior to the start of the experiment. λDNA (48,502 bp) and biotinylated-λDNA/Hind III fragments were obtained from Life Technologies. A biotinylated 2.1-kb DNA sample was prepared using standard PCR protocol. The 2.1-kb product was verified by slab-gel electrophoresis in comparison with λDNA/Hind III digest on 1.2% (wt/wt) agarose using ethidium bromide. The product was then isolated using a 1% agarose slab gel. The band was excised from the gel and the DNA was extracted using an appropriately assembled separation tube (Millipore Ultrafree-DA) according to the manufacturer's directions. This was followed with two aqueous washes. The final DNA concentration was measured using UV absorbance (A₂₆₀).

Preparation of YOYO-1 and POPO-III Mix-Labeled λDNA.

Individual molecules of YOYO-I labeled DNA have a much stronger fluorescence than POPO-III labeled DNA when excited at 488-nm. In order to observe the combined spectra from DNA molecules labeled with both dyes, the amount of YOYO-I:POPO-III was kept at 1:20. For uniform labeling, the two dyes were mixed and diluted first before DNA samples were added.

Reaction of Biotinylated DNA with Avidin-Conjugated R-phycoerythrin.

Avidin-conjugated R-phycoerythrin (Molecular Probes) was diluted 100 times with buffer (above) and then mixed directly with the biotinylated DNA. The mixing ratio was 1 DNA molecule per 1.2 avidin-conjugated R-phycoerythrin molecules with a final total concentration of 200-pM DNA. In order to promote reaction efficiency, the solution was agitated using the lowest speed of a vortex mixer. The reaction was performed at room temperature in the dark.

Microchannel Assembly.

A seven-channel fused-silica chip, custom manufactured by Alberta Microelectronics Corporation (Alberta, Canada), was used for all experiments. The overall chip dimensions were 4.5 cm×2.54 cm. Each channel was 10-μm deep, 300-μm wide and 3.5-cm long. Two pipette tips (5-μl capacity) were cut to fit the orifice at the end of each channel and immobilized with epoxy. These tips served as sample reservoirs. The chip was placed on the hypotenuse face of a right-angle fused-silica prism (Melles Griot, Irvine, Calif.; Prism UVGSFS, A=B=C=2.54 cm). The chip and the prism were index-matched with a drop of type FF immersion oil (R. P. Cargille Laboratories, Inc., Cedar Grove, N.J.). The prism and the microchannel were fixed to a sturdy holder to minimize realignment after sample changes. The fragility of the chips requires that the chip be perfectly flush with the prism surface and the prism holder so that it does not break during sample changes or channel cleanings. Before each set of experiments, the channel was washed with spectrophotometric grade methanol and filtered ultra-pure H₂O. The channel was also pretreated with 0.3% (wt/vol) PVP 1,300,000 Mᵣ in 50-mM Gly-Gly buffer to prevent the sample from adsorbing to the channel wall. All of the solutions were initially introduced into the channel by pressure with a 1-mil syringe which was modified with a rubber adapter. A home-built −1250 V D.C. power supply with two platinum electrodes was used to move the molecules through the channel so that a new set of molecules can be imaged in successive frames.

Equipment Setup.

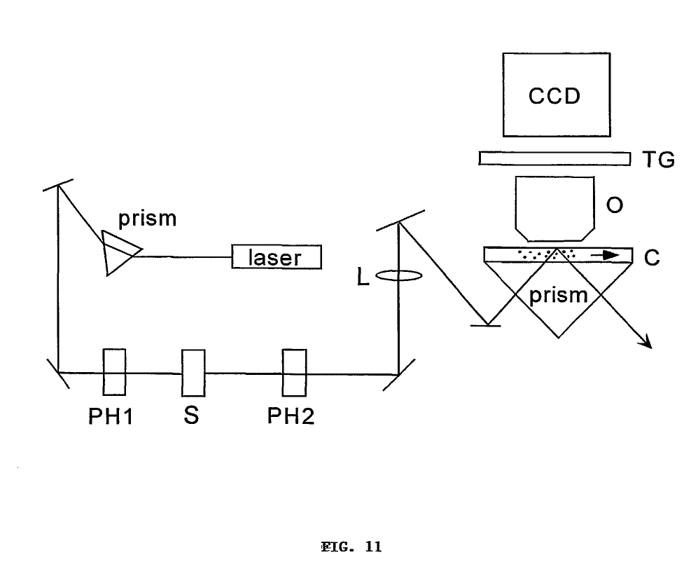

The experimental setup for this study is shown in FIG. 11, in which “PH1” and “PH2” are pinholes, “S” is a mechanical shutter, “L” is a lens in line with various focusing mirrors (represented by lines), “C” is the microchannel, “O” is the microscope objective, “TG” is the transmission grating, and “CCD” is the camera. A Pentamax 512-EFT/1EIA intensified CCD (ICCD, Princeton Instruments) camera was mounted on top of a Zeiss Axioskop upright microscope. The digitization rate of the camera was 5 MHz (12 bits) with the software controller gain set at 3 and the hardware intensifier gain set at 950 V (maximum). The camera was operated in the external synchronization mode with the intensifier disabled open. The camera was in the frame-transfer mode. The excitation source was an argon-ion laser at 488 nm with 40-mW output (Uniphase, San Jose, Calif.). Extraneous light and plasma lines from the laser were eliminated prior to its entry into the observation region with the aid of an equilateral dispersing prism and an optical pinhole. The laser beam was focused with a 20-cm focal length lens through the right-angle prism at an angle of 50° relative to the normal to the microchannel surface. At this angle, the laser light was totally reflected from the top surface of the channel to prevent scattered light from reaching the ICCD camera. Two 488-mn holographic notch filters (Kaiser Optical, Ann Arbor, Mich.; HNFP) with optical density of >6 were placed between the objective and the ICCD. A Zeiss 20×/0.75 n.a. plan Apochromat microscope objective was used to collect the fluorescence from the channel. A transmission grating with 70 lines/mm (Edmund Scientific, Barrington, N.J.) was mounted in front of the ICCD camera to disperse fluorescence from each molecule. Timing was controlled with a Uniblitz mechanical shutter (model LS2Z2, Vincent Associates, Rochester, N.Y.) with a frame rate of 7-10 Hz.

When light passes through a transmission grating in an arrangement such as the one described here, it is divided into a non-dispersed zero-order image and higher-order spectrally dispersed images. The physical separation between the orders is well-defined and is a function of the distance between the grating and the ICCD and the properties of the grating. The zero-order image is identical to that obtained without the grating but provides an inherent reference point for wavelength calibration for each molecule. As the grating is translated away from the ICCD camera, the separation between the orders increases and the fluorescence spectrum covers a greater number of pixels to provide higher resolution.

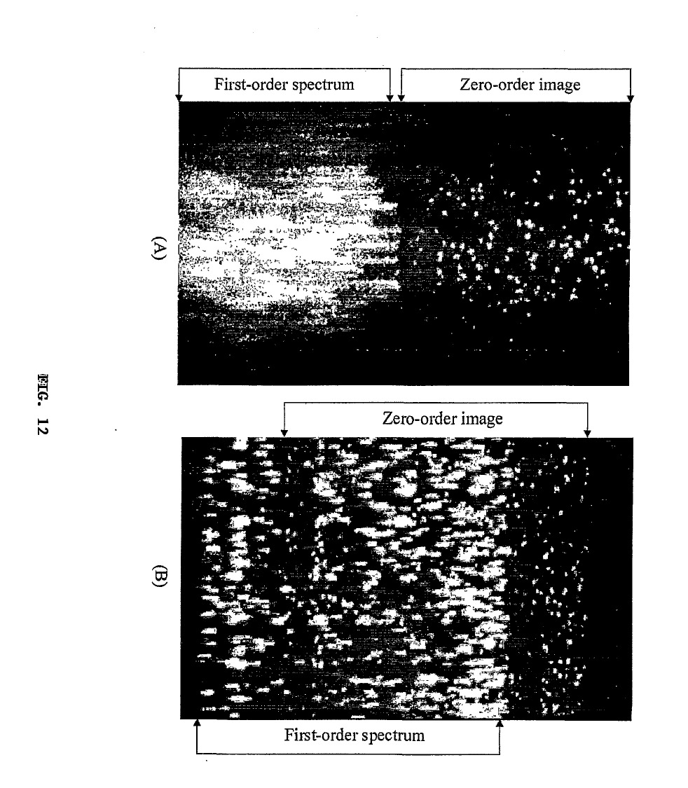

With the grating positioned 16.5 cm from the ICCD, the distance between the zero-order image and the intensity maximum in the first-order spectrum for each YOYO-1 labeled λDNA molecule is 278±6 pixels (see FIG. 12(A), which is an image of the complete separation of the zero-order images and first-order spectra generated during high-throughput single-molecule spectroscopy of YOYO-1-labeled λDNA). It is clear that the zero-order fluorescence image from each molecule is a tightly-focused spot while the first-order fluorescence spectrum from each molecule is a long streak. The channel width (300 μm) spans one-half the height of the image and was chosen so that the number of molecules imaged in one frame was maximized. With these settings, there is no overlap between the orders. The lower half of the image (first order) in FIG. 12(A) looks congested, but since the location of each molecule is unambiguous in the top half (zeroth order), even partially overlapping streaks can be deconvoluted and associated with distinct molecules. In general practice, this level of dispersion and spectroscopic resolution is not required for identifying molecules. In fact, a high dispersion decreases the throughput (number of molecules that can be imaged at one time) because each spectrum occupies more pixels within the image. The signal-to-noise ratio (S/N) is also compromised because the available photons from each molecule have to be spread out over many pixels.

At a lower spectral dispersion, depending on the distance between the grating and the ICCD, spectra from molecules on one side (top) of the channel may overlap the undispersed images of molecules at the other side (bottom) of the channel (see FIG. 12(B), which is an image of the partial separation of the zero-order images and first-order spectra generated during high-throughput single-molecule spectroscopy of YOYO-1-labeled λDNA). Decreasing the magnification factor of the optics to allow imaging wider channels mitigates this problem in part. However, low magnification objectives have less light gathering power and there is a concomitant loss in the S/N. For moderately dense images (FIG. 12(B)), it is not necessary to separate totally the zero-order image from the first-order spectrum. The two orders can simply be distinguished based on their shapes (spots vs. streaks). For YOYO-1 labeled λDNA with the grating positioned 3.5 cm from the ICCD, the distance between the zero- and the first-order fluorescence images is 61±0.5 pixels. The first-order fluorescence image in FIG. 12(B) is also much shorter (about 3-4 pixels) compared to those in FIG. 12(A) (15-20 pixels). In cases where the molecule density is high, narrower channels can be used while keeping the low dispersion or larger ICCD arrays can be employed at high dispersion to increase the throughput without introducing ambiguity.

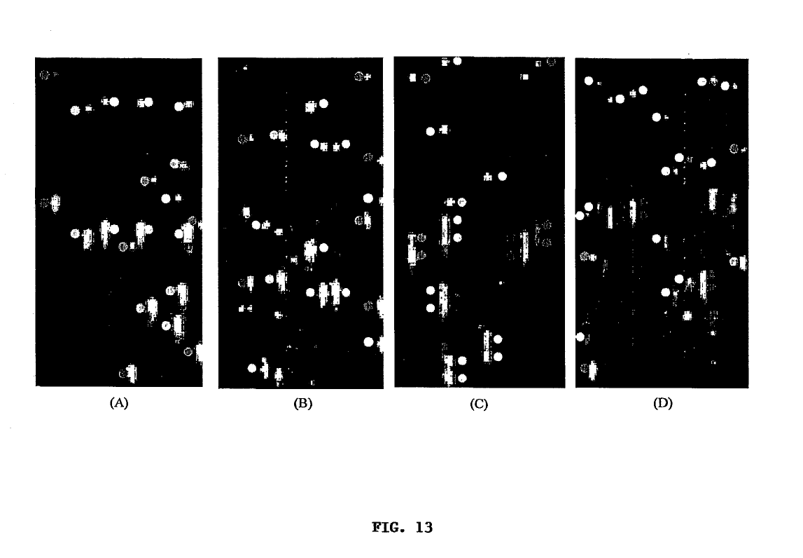

To demonstrate that this method can be used to discriminate molecules based on their inherent spectroscopic characteristics, a series of samples with different emission spectra were imaged (FIG. 13). FIG. 13 is a set of images of the single-molecule spectra of YOYO-1-labeled λDNA (A), POPO-III-labeled λDNA (B), YOYO-1 and POPO-III mix-labeled λDNA (C), and a mixture of all three types of labeled λDNA (D). The zero-order images and the corresponding first-order spectra were individually labeled with unique colors. The first-order spectra allow easy identification of each molecule. POPO-III-labeled λDNA emits at a longer wavelength (570 nm) than YOYO-1-labeled λ DNA (510 nm). In the former case, the distance between the zero-order image and the first-order spectrum was 69±0.5 pixels (FIG. 13(B)), whereas the distance in the latter case was 61±0.5 pixels (FIG. 13(A)). Therefore, the spectral resolution of the system is around 7 nm (=1 pixel), which is sufficient to distinguish among the molecules with no ambiguity. The mixed labeled molecules (FIG. 13(C)) show two emission maxima each. These correspond exactly to the emission maxima of the individual dyes. The maxima corresponding to POPO-III in FIG. 13(C) is much more intense than is predicted from the labeling ratio and the relative fluorescence efficiency. This enhancement is due to energy transfer from YOYO-1 to POPO-II in the same molecule. Therefore, one can in principle distinguish between a mixed-labeled molecule from two singly-labeled molecules that happen to be near each other but outside the Förster energy transfer range (Weiss, Science (Washington, D.C.) 283: 1679-1683 (1999)).

The separation between the zero-order image and the first-order spectrum is predictable based on the imaging optics. For normal incidence to the grating, the dispersed image occurs at an angle Θ such that λ=dsinΘ. For 510 nm light and d=1/70 mm, sin θ=0.036 =θ. At a physical distance of 3.5 cm (FIG. 12(B)), the calculated displacement is 1,250 μm, or 65.7 pixels for the 19-μm pixel spacing of the CCD element. For 570 nm light, the calculated displacement is 73.5 pixels. The observed absolute displacement is off by 7% but the relative displacement is exactly as predicted. A similar deviation was found for the absolute displacement in FIG. 12(A). The presence of refraction due to the window in front of the CCD element explains the discrepancy.

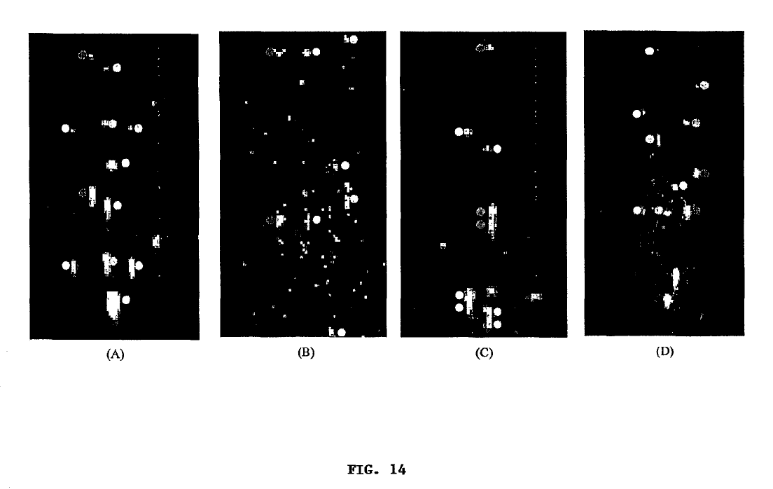

To evaluate the potential of single-molecule spectroscopy for monitoring interactions between molecules with different emission characteristics, the avidin-biotin conjugation reaction was used as a model system. Biotinylated DNA (2.1 kb) was labeled with YOYO-1 and then reacted with avidin modified R-phycoerythrin. After the reaction, the DNA-phycoerythrin complex will take on a separate spectral characteristic. The spectra of the two reactants are readily recognizable because YOYO-1 emits at 510 nm while R-phycoerythrin emits at 570 nm. The individual and combined spectra are shown in FIG. 14, which is a set of images of the single-molecule spectra of YOYO-1-labeled biotinylated 2.1 kb DNA (A), avidin conjugated R-phycoerythrin (B), conjugated DNA and R-phycoeythrin (C), and a mixture of conjugated DNA and R-phycoerythrin, YOYO-1-labeled 2.1 kb DNA (no biotin) and R-phycoerythrin (no avidin) (D)). The individual and combined spectra verify that unambiguous discrimination is possible. The distance between the zero- and first-order images for YOYO-1 labeled biotinylated 2.1-kb DNA (FIG. 14(A)) is 61±0.5 pixels. The separation between the zero- and first-order images for avidin conjugated R-phycoerythrin (FIG. 14(B)) is 69±0.5 pixels. Conjugated DNA and R-phycoerythrin appeared as one spot in zero order and a more dispersed spot with two maxima in first order (FIG. 14(C)). As above, the spectra are a combination of those for the individual components. There is also energy transfer from YOYO-1 to R-phycoerythrin. To further validate these results, a solution of 2.1-kb DNA, which was not biotinylated, was prepared and mixed with R-phycoerythrin that contains no avidin. This solution was further mixed with the DNA-phycoerythrin complex. Since the fluorescence of R-phycoerythrin is substantially weaker than that of YOYO-1 labeled biotinylated 2.1-kb DNA, the labeling ratio of YOYO-1 DNA was decreased to 1 dye per 20 bp. The spectrum of each component was readily distinguishable from one another in the same image (FIG. 4(D)). In order to see a clear fluorescence signal from R-phycoerythrin, the laser needs to be well-focused and background subtraction needs to be applied to the raw data. The size of the excitation area is reduced as a result. A higher total laser power would afford a larger focused spot and permit the observation of R-phycoerythrin molecules over the whole channel.

This approach provides for highly efficient collection of fluorescence emission spectra from single molecules. The transmission grating essentially introduces no loss to the imaging system. The particular grating employed here is 20% efficient in zero order and 80% efficient in first order. This maintains an ideal balance in S/N because the former image is not dispersed but the latter spectrum is spaced out over many pixels. The transmission grating further allows the use of high numerical aperture objectives to maximize light collection.

The exposure time and the favorable chromophores selected here were dictated by the use of a low-power cw laser in the chopped mode. Exposure time in the low millisecond range is short enough to freeze essentially these large molecules in space (Xu et al., Science (Washington, D.C.) 275: 1106-1109 (1997)) to provide a well-defined zero-order image and a clean first-order line spectrum. Since only one exposure is needed to record the spectra of all molecules in the field of view, the use of a high-power cw laser or even a low-power pulsed laser will shorten the total measurement times to the microsecond regime. Then, even small molecules in free solution will be imaged without smearing due to diffusion (Xu et al. (1997), supra; Xu et al., Science (Washington, D.C.) 281: 1650-1653 (1998)). The lower limit in exposure time will be determined by the cycle time to and from the excited state of the molecule, since many photons are needed to record a spectrum. For example, 1 μsec will suffice for generating several hundred photons from a molecule having a fluorescence lifetime of several nsec.

The ability to record single-molecule spectra in free solution has many potential applications. DNAs can be probed by complementary short strands with suitable fluorescence labels (Konig et al., Single Mol. 1: 41-51 (2000)). Proteins and small molecules can be recognized on binding with suitable antibodies. Previous studies of single-molecule interactions (Xu et al. (1998), supra; Mehta et al., PNAS USA 94: 7927-7931 (1997); Ha et al., PNAS USA 93: 6264-6268 (1996); Harada et al., Biophys. J. 76: 709-715 (1999); Sako et al., Nat. Cell. Biol. 2: 168-172 (2000); Tokunaga et al., Biochem. Biophys. Res. Commun. 235: 47-53 (1997); Trabesinger et al., Anal. Chem. 71: 279-283 (1999); and Ye et al., Chem. Phys. Lett. 320: 607-612 (2000)) can now be performed in free solution, i.e., without immobilizing either reactants. Compared to intensity-based discrimination of molecules (Van Orden et al. (2000), supra), the emission spectra provides additional selectivity. Compared to distinguishing molecules based on their electrophoretic mobilities, the acquisition of spectra can be performed at much higher speeds. This is because a time delay is inherent to mobility measurements. Based on FIG. 12(B), one can probably record the spectra of 300 molecules per image. The estimate is based on requiring an average spacing (in first order) between molecules of 20 pixels horizontally and 20 pixels vertically in half of a 512×512 CCD image. State-of-the-art CCD imagers can be read out every msec. If the molecules in the channel can be transported completely out of the channel every msec, e.g. by applying a high voltage axially along the channel, the net performance will be 300,000 molecules screened every sec. This level of throughput requires suitable imaging software to analyze the data at these high speeds.

### Incorporation by Reference

All sources (e.g., inventor's certificates, patent applications, patents, printed publications, repository accessions or records, utility models, World-Wide Web pages, and the like) referred to or cited anywhere in this document or in any drawing, Sequence Listing, or Statement filed concurrently herewith are hereby incorporated into and made part of this specification by such reference thereto.

### Guide to Interpretation

The foregoing is an integrated description of the invention as a whole, not merely of any particular element or facet thereof. The description describes “preferred embodiments” of this invention, including the best mode known to the inventors for carrying it out. Of course, upon reading the foregoing description, variations of those preferred embodiments will become obvious to those of ordinary skill in the art. The inventors expect ordinarily skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law.

As used in the foregoing description and in the following claims, singular indicators (e.g., “a” or “one”) include the plural, unless otherwise indicated. Recitation of a range of discontinuous values is intended to serve as a shorthand method of referring individually to each separate value falling within the range, and each separate value is incorporated into the specification as if it were individually listed. As regards the claims in particular, the term “consisting essentially of” indicates that unlisted ingredients or steps that do not materially affect the basic and novel properties of the invention can be employed in addition to the specifically recited ingredients or steps. In contrast, the terms “comprising,” “having,” or “incorporating” indicate that any ingredients or steps can be present in addition to those recited. The term “consisting of” indicates that only the recited ingredients or steps are present, but does not foreclose the possibility that equivalents of the ingredients or steps can substitute for those specifically recited.

What is claimed is:

1. A high-throughput method of distinguishing at least one molecule individually in a sample comprising multiple molecules, which method comprises:
(i) subjecting a sample comprising multiple molecules, at least one molecule of which is detectably labeled, to electrophoresis,
(ii) imaging the electrophoretic mobility of each detectably labeled molecule over time by detecting the position of the detectable label of each detectably labeled molecule over time and, optionally, at the same time, dispersing the imaging by a transmission grating for spectroscopic analysis, and
(iii) determining the electrophoretic mobility of each detectably labeled molecule and, optionally, determining the molecular spectrum of each detectably labeled molecule,
thereby distinguishing at least one molecule individually in a ample comprising multiple molecules.

2. The high-throughput method of claim 1, wherein said multiple molecules in said sample are not amplified prior to being subjected to electrophoresis.

3. The high-throughput method of claim 1, wherein said at least one molecule is a nucleic acid.

4. The high-throughput method of claim 3, wherein said nucleic acid is detectably labeled with a fluorescent label.

5. The high-throughput method of claim 1, wherein said at least one molecule is a protein.

6. The high-throughput method of claim 5, wherein said protein is detectably labeled with a fluorescent label.

7. The high-throughput method of claim 1, wherein said at least one molecule is a small molecule.

8. The high-throughput method of any of claims 1-7, wherein said sample comprises a buffer.

9. The high-throughput method of claim 8, wherein said buffer is photobleached.

10. The high-throughput method of claim 8, wherein said buffer comprises a sieving matrix.

11. The high-throughput method of claim 4 or 6, wherein said fluorescent label is induced to fluoresce by a laser.

12. The high-throughput method of any of claims 4, 6 and 11, wherein fluorescence from said fluorescent label is focused on an imaging means.

13. The high-throughput method of claim 12, wherein said imaging means is an intensified CCD camera.

14. The high-throughput method of any of claims 11-13, wherein said laser generates extraneous light and said extraneous light is eliminated through the use of an equilateral prism and at least one optical pinhole positioned before said imaging means.

15. The high-throughput method of claim 12 or 13, wherein one or more optical filters are positioned in front of said imaging means.

16. The high-throughput method of any of claims 1-15, wherein said electrophoretic mobility is measured by a method selected from the group consisting of the multiframe method, the streak method and the multispot method.

17. The high-throughput method of any of claims 1-16, wherein said electrophoretic mobility is imaged in less than about 5 milliseconds.

18. The high-throughput method of any of claims 1-17, wherein the at least one detectably labeled molecule is present in said sample at a concentration of at least about 1 copy per millilter.

19. The high-throughput method of any of claims 1-18, wherein at least about 200 detectably labeled molecules are imaged every 10 milliseconds.

20. The high-throughput method of claim 19, wherein at least about 2,500 detectably labeled molecules are imaged every 25 milliseconds.

21. A system for use in the method of claim 1, which system comprises:
(i) an electrophoretic sample channel, into which is introduced a sample comprising multiple molecules, at least one molecule of which is detectably labeled with a fluorescent label,
(ii) a light source comprising or consisting essentially of at least one wavelength of light that causes at least one molecule in said sample comprising multiple molecules that is detectably labeled with a fluorescent label to fluoresce, wherein said light source irradiates said electrophoretic sample channel,
(iii) an imaging means, wherein said imaging means images the electrophoretic mobility of each detectably labeled molecule in said sample over time, and, optionally,
(iv) a transmission grating, which disperses the imaging of the electrophoretic mobility of each detectably labeled molecule in said sample.

22. The system of claim 21, which further comprises a lens between said light source and said electrophoretic sample channel, wherein said lens focuses said light at normal incidence to said electrophoretic sample channel.

23. The system of claim 21 or 22, wherein said laser generates extraneous light and said system further comprises an equilateral prism and at least one optical pinhole before said imaging means, wherein said equilateral prism and said at least one optical pinhole eliminate said extraneous light prior to it impinging on said imaging means.

24. The system of any of claims 21-23, wherein said imaging means is an intensified CCD camera.

25. The system of claim 24, which further comprises a microscope objective between said electrophoretic sample channel and said imaging means, wherein said microscope objective focuses the fluorescence from said fluorescent label onto said imaging means.

26. The system of claim 21 or 22, which further comprises one or more optical filters positioned in front of said imaging means.

27. The system of any of claims 21-26, wherein said imaging means images the electrophoretic mobility of a detectably labeled molecule in said sample in less than about 5 milliseconds.

28. The system of any of claims 21-26, wherein said imaging means images the electrophoretic mobility of at least about 200 detectably labeled molecules every 10 milliseconds.

29. The system of any of claims 21-26, wherein said imaging means images the electrophoretic mobility of at least about 2,500 detectably labeled molecules every 25 milliseconds.

30. A high-throughput method of distinguishing at least one molecule individually in a sample comprising multiple molecules, which method comprises:
(i) introducing a sample comprising multiple molecules in free solution, at least one molecule of which is detectably labeled, into a sample channel,
(ii) simultaneously imaging the position of each detectably labeled molecule by detecting the position of the detectable label of each detectably labeled molecule and dispersing the imaging by a transmission grating for spectroscopic analysis, and
(iii) determining the molecular spectrum of each detectably labeled molecule,
thereby distinguishing at least one molecule individually in a sample comprising multiple molecules.

31. The high-throughput method of claim 30, wherein said multiple molecules in said sample are not amplified prior to being introduced into said sample channel.

32. The high-throughput method of claim 30, wherein said at least one molecule is a nucleic acid.

33. The high-throughput method of claim 32, wherein said nucleic acid is detectably labeled with a fluorescent label.

34. The high-throughput method of claim 30, wherein said at least one molecule is a protein.

35. The high-throughput method of claim 34, wherein said protein is detectably labeled with a fluorescent label.

36. The high-throughput method of claim 30, wherein said at least one molecule is a small molecule.

37. The high-throughput method of any of claims 29-36, wherein said sample comprises a buffer.

38. The high-throughput method of claim 37, wherein said buffer is photobleached.

39. The high-throughput method of claim 33 or 35, wherein said fluorescent label is induced to fluoresce by a laser.

40. The high-throughput method of any of claims 33, 35 and 39, wherein fluorescence from said fluorescent label is focused on an imaging means.

41. The high-throughput method of claim 40, wherein said imaging means is an intensified CCD camera.

42. The high-throughput method of any of claims 39-41, wherein said laser generates extraneous light and said extraneous light is eliminated through the use of an equilateral prism and at least one optical pinhole positioned before said imaging means.

43. The high-throughput method of claim 40 or 41, wherein one or more optical filters are positioned in front of said imaging means.

44. The high-throughput method of any of claims 30-43, wherein said position is imaged in less than about 0.05 milliseconds.

45. The high-throughput method of any of claims 30-44, wherein said at least one detectably labeled molecule is present in said sample at a concentration of at least about 1 copy per millilter.

46. The high-throughput method of any of claims 30-45, wherein at least about 200 detectably labeled molecules are imaged every 0.10 milliseconds.

47. The high-throughput method of claim 46, wherein at least about 2,500 detectably labeled molecules are imaged every 0.25 milliseconds.

48. A system for use in the method of claim 30, which system comprises:
(i) a sample channel, into which is introduced a sample comprising multiple molecules in free solution, at least one molecule of which is detectably labeled with a fluorescent label,
(ii) a light source comprising or consisting essentially of at least one wavelength of light that causes at least one molecule in said sample comprising multiple molecules that is detectably labeled with a fluorescent label to fluoresce, wherein said light source irradiates said sample channel,
(iii) an imaging means, wherein said imaging means images the position of each detectably labeled molecule in said sample, and,
(iv) a transmission grating, which simultaneously disperses the imaging of the position of each detectably labeled molecule in said sample.

49. The system of claim 48, which further comprises a lens between said light source and said sample channel, wherein said lens focuses said light at normal incidence to said sample channel.

50. The system of claim 49, wherein said laser generates extraneous light and said system further comprises an equilateral prism and at least one optical pinhole before said imaging means, wherein said equilateral prism and said at least one optical pinhole eliminate said extraneous light prior to it impinging on said imaging means.

51. The system of any of claims 48-50, wherein said imaging means is an intensified CCD camera.

52. The system of claim 51, which further comprises a microscope objective between said sample channel and said imaging means, wherein said microscope objective focuses the fluorescence from said fluorescent label onto said imaging means.

53. The system of any of claims 48-52, which further comprises one or more optical filters positioned in front of said imaging means.

54. The system of any of claims 48-53, wherein said imaging means images the position of a detectably labeled molecule in said sample in less than about 0.05 milliseconds.

55. The system of any of claims 48-54, wherein said imaging means images the position of at least about 200 detectably labeled molecules every 0.10 milliseconds.

56. The system of any of claims 48-54, wherein said imaging means images the position of at least about 2,500 detectably labeled molecules every 0.25 milliseconds.
